(19) United States
(12) Patent Application Publication
(10) Pub. No.: US 2019/0089738 A1
(43) Pub. Date: Mar. 21, 2019

(54) ESTABLISHING A PROPRIETARY LINK LAYER CONNECTION WITH A PROPRIETARY DEVICE

(71) Applicant: QUALCOMM Incorporated, San Diego, CA (US)

(72) Inventors: Brian REDDING, Urbana, IL (US); Robin HEYDON, Cambridge (GB); Joel LINSKY, San Diego, CA (US)

(21) Appl. No.: 15/710,404

(22) Filed: Sep. 20, 2017

(51) Int. Cl. H04L 29/06

(52) U.S. Cl. CPC H04L 63/162; H04L 45/02; H04L 63/0869; H04L 63/04

(57) ABSTRACT

The apparatus may establish a non-proprietary link layer connection with a second device. The apparatus may determine if a first set of empty non-proprietary link layer PDUs are exchanged with the second device via one or more channels during a non-proprietary link layer connection event. The apparatus may exchange proprietary establishment PDUs with the second device during at least one proprietary link establishment event via the one or more channels when it is determined that the first set of empty non-proprietary link layer PDUs are exchanged with the second device via the one or more channels. The apparatus may establish a proprietary link layer connection with the second device when it is determined that a sequence of the proprietary establishment PDUs have been exchanged with the second device. The apparatus may communicate with the second device via the proprietary link layer connection.

### BACKGROUND

### Field

The present disclosure relates generally to communication systems, and more particularly, to establishing a proprietary link layer (QLL) connection with a proprietary device.

### Background

A wireless personal area network (WPAN) is a personal, short-range area wireless network for interconnecting devices centered around a specific distance from a user. WPANs have gained popularity because of the flexibility and convenience in connectivity that WPANs provide. WPANs, such as those based on short-range communication protocols (e.g., a Bluetooth® (BT) protocol, BT low-energy (BLE) protocol, a Zigbee® protocol, etc.), provide wireless connectivity to peripheral devices by providing short-range wireless links that allow connectivity within a specific distance (e.g., 5 meters, 10 meter, 20 meters, 100 meters, etc.).

BT is a short-range wireless communication protocol that supports a WPAN between a central device (e.g., a master device) and at least one peripheral device (e.g., a slave device). Power consumption associated with BT communications may render BT impractical in certain applications, such as applications in which an infrequent transfer of data occurs.

To address the power consumption issue associated with BT, BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may established using, e.g., hardware, firmware, host operating system, host software stacks, and/or host application support. Example applications that use BLE include battery-operated sensors and actuators in various medical, industrial, consumer, and fitness applications that connect to devices such as BLE enabled smart phones, tablets, and laptops. While traditional BLE offers certain advantages, there exists a need for further improvements in BLE technology.

For example, in certain scenarios it may be beneficial to establish a QLL communication link between two proprietary devices that is independent of the hardware, firmware, host operating system, host software stacks, and/or host application support. By establishing a QLL communication link that is independent of the hardware, firmware, host operating system, host software stacks, and/or host application support, services such as firmware updates, licensing additional codes, and/or adding additional firmware components on peer devices with minimal peer host software support may be supported.

There exists a need for a technique to establish a QLL communication link between two proprietary devices that is independent of the hardware, firmware, host operating system, host software stacks, and/or host application support.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may be established using, e.g., hardware, firmware, host operating system, host software stacks, and/or host application support. Example applications that use BLE include battery-operated sensors and actuators in various medical, industrial, consumer, and fitness applications that connect to devices such as BLE enabled smart phones, tablets, and laptops. While traditional BLE offers certain advantages, there exists a need for further improvements in BLE technology.

For example, in certain scenarios it may be beneficial to establish a QLL communication link between two proprietary devices that is independent of the hardware, firmware, host operating system, host software stacks, and/or host application support. By establishing a QLL communication link that is independent of the hardware, firmware, host operating system, host software stacks, and/or host application support, services such as firmware updates, licensing additional codes, and/or adding additional firmware components on peer devices with minimal peer host software support may be supported.

There exists a need for a technique to establish a QLL connection between two proprietary devices that is independent of the hardware, firmware, host operating system, host software stacks, and/or host application support.

The present disclosure provides a QLL protocol that exists alongside of the Link Layer (LL) in the BLE protocol stack. The QLL protocol may be used to discover other proprietary devices. The QLL protocol may also be used to establish a secure QLL communication link with another proprietary device that is independent of the hardware, firmware, host operating system, host software stacks, and/or host application support in order to support services such as firmware updates, licensing additional codes, and/or adding additional firmware components.

In an aspect of the disclosure, a method, a computer-readable medium, and an apparatus are provided. The apparatus may establish a non-proprietary link layer connection with a second device. The apparatus may determine if a first set of empty non-proprietary link layer PDUs are exchanged with the second device via one or more channels during a non-proprietary link layer connection event. The apparatus may exchange proprietary establishment PDUs with the second device during at least one proprietary link establishment event via the one or more channels when it is determined that the first set of empty non-proprietary link layer PDUs are exchanged with the second device via the one or more channels. The apparatus may establish a proprietary link layer connection with the second device when it is determined that a sequence of the proprietary establishment PDUs have been exchanged with the second device. The apparatus may communicate with the second device via the proprietary link layer connection.

In certain other configurations, the apparatus may establish a proprietary link layer connection with a second device. For example, the apparatus may establish the proprietary link layer connection with the second device by transmitting an initial proprietary establishment PDU on a plurality of advertising channels. The apparatus may establish the proprietary link layer connection with the second device by listening for a response proprietary establishment PDU on each of the plurality of advertising channels after the initial advertising PDU is transmitted. The apparatus may establish the proprietary link layer connection with the second device by exchanging subsequent proprietary establishment PDUs with the second device on the advertising channel on which the response proprietary establishment PDU is received. The apparatus may communicate with the second device via the proprietary link layer connection.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN in accordance with certain aspects of the disclosure.

FIG. 2 is block diagram of a BLE device in accordance with certain aspects of the disclosure.

FIG. 3 is a diagram illustrating a modified BLE protocol stack that may include a QLL in accordance with certain aspects of the disclosure.

FIG. 4A illustrates a data flow that may be used to establish a QLL communication link in accordance with certain aspects of the disclosure.

FIG. 4B illustrates a QLL establishment protocol that may be used to establish a QLL communication link by exchanging a particular sequence of QLL establishment PDUs in accordance with certain aspects of the disclosure.

FIG. 4C illustrates a QLL establishment protocol that may be used to establish a QLL communication link by exchanging a particular sequence of QLL establishment PDUs in accordance with certain aspects of the disclosure.

FIG. 4D illustrates an initiation of QLL establishment protocol over an advertising establishment bearer in accordance with certain aspects of the disclosure.

FIG. 4E illustrates a QLL establishment protocol that may be used to establish a QLL communication link over an advertising establishment bearer in accordance with certain aspects of the disclosure.

FIGS. 5A and 5B are a flowchart of a method of wireless communication.

FIG. 6 is a conceptual data flow diagram illustrating the data flow between different means/components in an exemplary apparatus.

FIG. 7 is a diagram illustrating an example of a hardware implementation for an apparatus employing a processing system.

FIG. 8 is a flowchart of a method of wireless communication.

FIG. 9 is a conceptual data flow diagram illustrating the data flow between different means/components in an exemplary apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

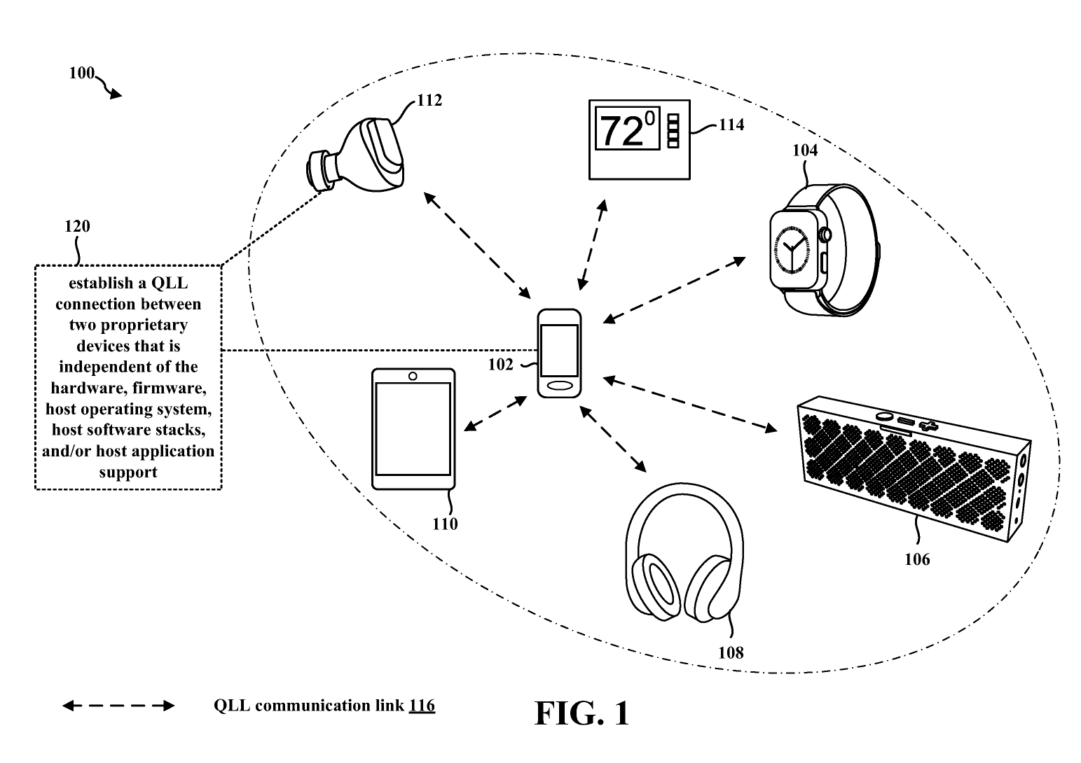

FIG. 1 illustrates an example WPAN 100 in accordance with certain aspects of the disclosure. Within the WPAN 100, a central device 102 may connect to and establish a QLL communication link 116 with one or more peripheral devices 104, 106, 108, 110, 112, 114 using a modified BLE protocol. The BLE protocol is a specification that enables radio frequency communication operating within the globally accepted 2.4 GHz Industrial, Scientific & Medical (ISM) band.

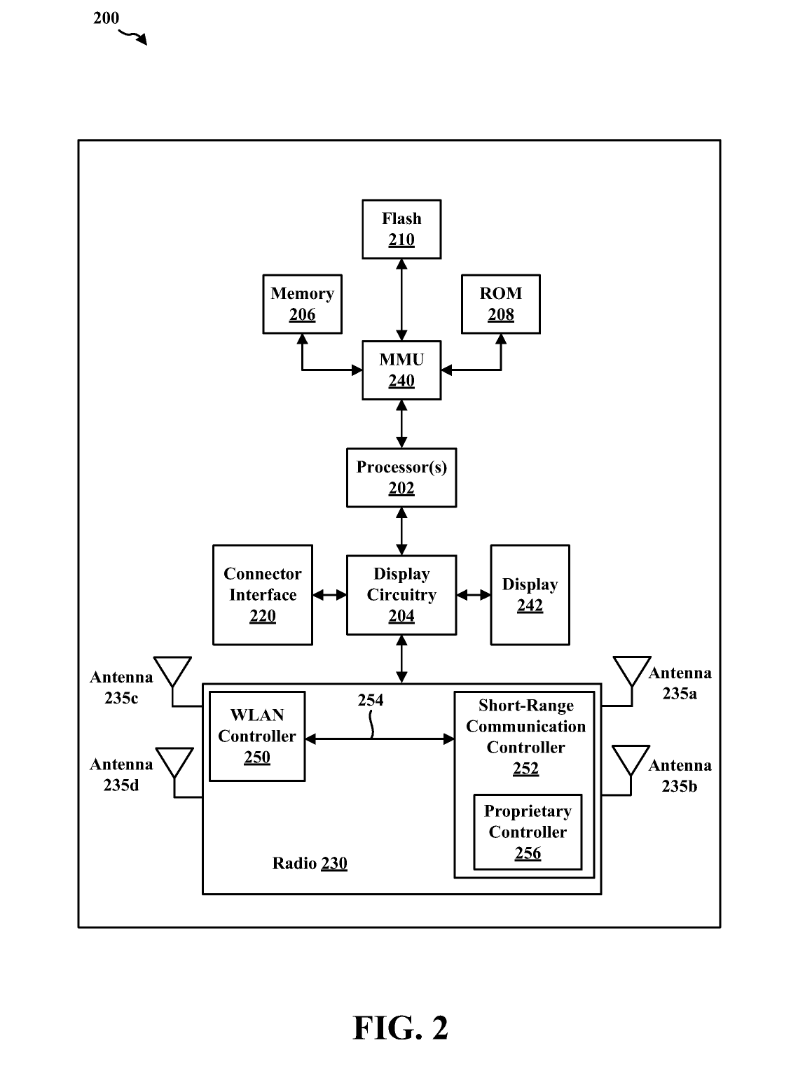

The central device 102 may include suitable logic, circuitry, interfaces, processors, and/or code that may be used to communicate with one or more peripheral devices 104, 106, 108, 110, 112, 114 using the BLE protocol or the modified BLE protocol as described below with reference to FIGS. 2-10. The central device 102 may operate as an initiator to request establishment of a LL connection with an intended peripheral device 104, 106, 108, 110, 112, 114.

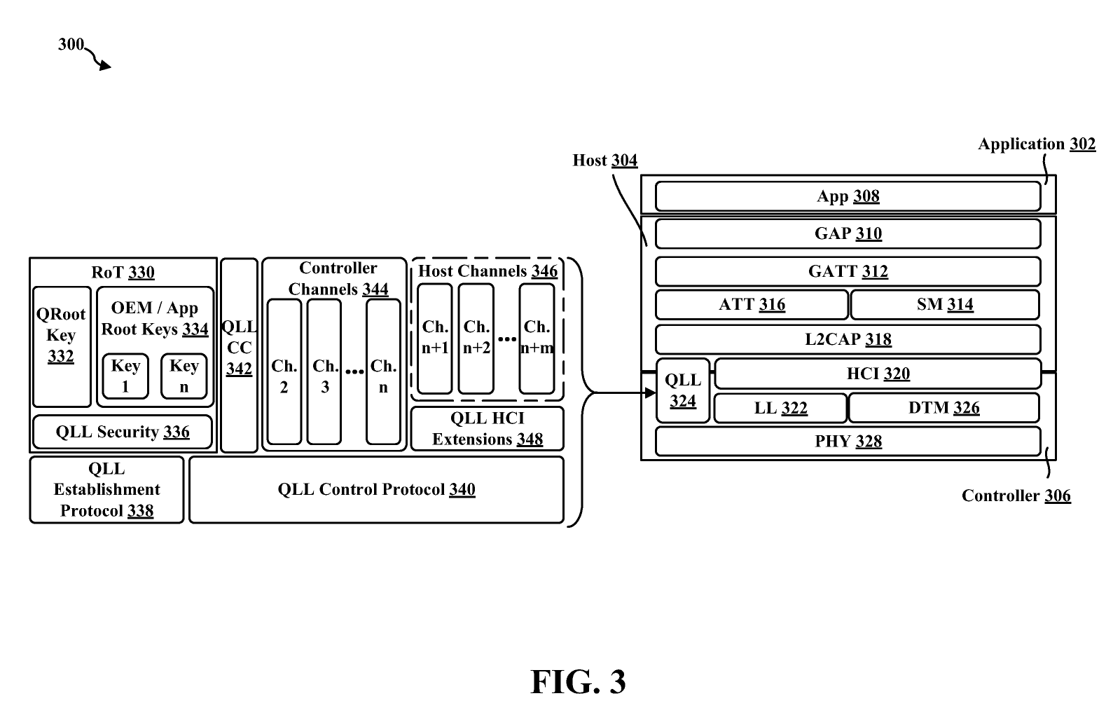

A LL in the BLE protocol stack (e.g., see FIG. 3) provides, as compared to BT, ultra-low power idle mode operation, simple device discovery and reliable point-to-multipoint data transfer with advanced power-save and encryption functionalities. After a requested LL connection is established, the central device 102 may become a master device and the intended peripheral device 104, 106, 108, 110, 112, 114 may become a slave device for the established LL connection. As a master device, the central device 102 may be capable of supporting multiple LL connections at a time to various peripheral devices 104, 106, 108, 110, 112, 114 (slave devices). The central device 102 (master device) may be operable to manage various aspects of data packet communication in a LL connection with an associated peripheral device 104, 106, 108, 110, 112, 114 (slave device). For example, the central device 102 may be operable to determine an operation schedule in the LL connection with a peripheral device 104, 106, 108, 110, 112, 114 (slave). The central device 102 may be operable to initiate a LL protocol data unit (PDU) exchange sequence over the LL connection. LL connections may be configured to run periodic connection events in dedicated data channels. The exchange of LL data PDU transmissions between the central device 102 and one or more of the peripheral devices 104, 106, 108, 110, 112, 114 may take place within connection events.

In certain configurations, the central device 102 may be configured to transmit the first LL data PDU in each connection event to an intended peripheral device 104, 106, 108, 110, 112, 114. In certain configurations, the central device 102 may utilize a polling scheme to poll the intended peripheral device 104, 106, 108, 110, 112, 114 for a LL data PDU transmission in a connection event. The intended peripheral device 104, 106, 108, 110, 112, 114 may transmit a LL data PDU upon receipt of packet LL data PDU from the central device 102. In certain other configurations, a peripheral device 104, 106, 108, 110, 112, 114 may transmit a LL data PDU to the central device 102 without first receiving a LL data PDU from the central device 102.

Once a LL connection has been established between the central device 102 (master device) and a peripheral device 104, 106, 108, 110, 112, 114 (slave device), the central device 102 may establish a QLL communication link when the peripheral device 104, 106, 108, 110, 112, 114 is a peer proprietary device. In certain aspects peer proprietary devices may be wireless devices that are both associated with the same company (e.g., Qualcomm®, Apple®, Samsung®, etc.). The QLL communication link may be used to support, e.g., firmware updates, licensing additional codes, adding additional firmware components, and/or updating the operating system just to name a few.

Examples of the central device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, 114 may include a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, 114 in the WPAN 100, the central device 102 may communicate with more or fewer than six peripheral devices within the WPAN 100 without departing from the scope of the present disclosure.

Referring again to FIG. 1, in certain aspects, the central device 102 may be configured to establish a QLL connection with one or more peripheral devices 104, 106, 108, 110, 112, 114 (e.g., a peer proprietary device) that is independent of the hardware, firmware, host operating system, host software stacks, and/or host application support (120).

FIG. 2 is block diagram of a wireless device 200 in accordance with certain aspects of the disclosure. The wireless device 200 may correspond to, e.g., the central device 102, and/or one of the peripheral devices 104, 106, 108, 110, 112, 114 in FIG. 1. In certain configurations, the wireless device 200 may be, e.g., a BLE device that is configured to implemented the modified BLE protocol stack described below with reference to FIG. 3.

As shown in FIG. 2, the wireless device 200 may include a processing element, such as processor(s) 202, which may execute program instructions for the wireless device 200. The wireless device 200 may also comprise display circuitry 204 which may perform graphics processing and provide display signals to the display 242. The processor(s) 202 may also be coupled to a memory management unit (MMU) 240, which may be configured to receive addresses from the processor(s) 202 and translate the addresses to locations in memory (e.g., memory 206, ROM 208, Flash memory 210) and/or to other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor 202 may be coupled to various other circuits of the wireless device 200. For example, the wireless device 200 may include various types of memory, a connector interface 220 (e.g., for coupling to the computer system), the display 242, and wireless communication circuitry configured to implement the modified BLE protocol stack described below with reference to FIG. 3. The wireless device 200 may include a plurality of antennas 235a, 235b, 235c, 235d, for performing wireless communication with, e.g., BLE devices, peer proprietary device, etc.

In certain aspects, the wireless device 200 may include hardware and software components (a processing element) configured to establish a QLL connection between two proprietary devices that is independent of the hardware, firmware, host operating system, host software stacks, and/or host application support, e.g., using the techniques described below with reference to FIGS. 3-10. The wireless device 200 may also comprise BLE firmware or other hardware/software for controlling the BLE operations, e.g., described below with reference to FIGS. 3-10. In addition, the wireless device 200 may store and execute a wireless local area network (WLAN) software driver for controlling WLAN operations, and/or a cellular software driver for controlling cellular operations.

The wireless device 200 may be configured to implement part or all of the techniques described below with reference to FIGS. 3-10, e.g., by executing program instructions stored on a memory medium (e.g., a non-transitory computer-readable memory medium) and/or through hardware or firmware operation. In other embodiments, the techniques described below with reference to FIGS. 3-10 may be at least partially implemented by a programmable hardware element, such as an field programmable gate array (FPGA), and/or as an application specific integrated circuit (ASIC).

In certain aspects, radio 230 may include separate controllers configured to control communications for various respective radio access technology (RAT) protocols. For example, as shown in FIG. 2, radio 230 may include a WLAN controller 250 configured to control WLAN communications and a short-range communications controller 252 configured to control short-range communications (e.g., BLE communications). The short-range communications controller 252 may include or be connected with a proprietary controller 256. In certain aspects, the proprietary controller 256 may be associated with a particular company (e.g., Qualcomm®, Apple®, Samsung®, etc.). For example, the proprietary controller 256 may be a Qualcomm® proprietary controller 256 that is configured to discover and establish a secure QLL communication link with a Qualcomm® proprietary controller in a remote wireless Qualcomm® device. In certain aspects, the proprietary controller 256 may be configured to establish a QLL connection between two proprietary devices that is independent of the hardware, firmware, host operating system, host software stacks, and/or host application support. A coexistence interface 254 (e.g., a wired interface) may be used for sending information between the WLAN controller 250 and the short-range communications controller 252/proprietary controller 256.

In some aspects, one or more of the WLAN controller 250, the short-range communications controller 252, and/or the proprietary controller 256 may be implemented as hardware, software, firmware or some combination thereof.

In certain aspects, the WLAN controller 250 may be configured to communicate with a second device using a WLAN link using all of the antennas 235a, 235b, 235c, 235d. In certain configurations, the short-range communications controller 252 and/or the proprietary controller 256 may be configured to implement a modified BLE protocol stack (see FIG. 3), and communicate with at least one second device using one or more of the antennas 235a, 235b, 235c, 235d.

FIG. 3 illustrates a modified BLE protocol stack 300 that may be implemented in a BLE device in accordance with certain aspects of the present disclosure. For example, the modified BLE protocol stack 300 may be implemented by, e.g., one or more of processor(s) 202, memory 206, Flash memory 210, ROM 208, the radio 230, the short-range communications controller 252, and/or the proprietary controller 256 illustrated in FIG. 2.

Referring to FIG. 3, the modified BLE protocol stack 300 may be organized into three blocks, namely, the Application 302, the Host 304, and the Controller 306. Application 302 may be a user application which interfaces with the other blocks and/or layers of the modified BLE protocol stack 300. The Host 304 may include the upper layers of the modified BLE protocol stack 300, and the Controller 306 may include the lower layers of the modified BLE protocol stack 300.

The Host 304 may communicate with a controller (e.g., short-range communications controller 252 and/or the proprietary controller 256 in FIG. 2) in a wireless device using a Host Controller Interface (HCl) 320. The HCl 320 may also be used to interface the Controller 306 with the Host 304. Interfacing the Controller 306 and the Host 304 may enable a wide range of Hosts to interface with the Controller 306.

The Application 302 may include a higher-level Application Layer (App) 308, and the modified BLE protocol stack 300 may run under the App 308. The Host 304 may include a Generic Access Profile (GAP) 310, a Generic Attribute Protocol (GATT) 312, a Security Manager (SM) 314, an Attribute Protocol (ATT) 316, and a Logical Link Control and Adaptation Protocol (L2CAP) 318, each of which are described in further detail below. The Controller 306 may include a LL 322, a QLL 324, a Direct Test Mode (DTM) 326, and a Physical Layer (PHY) 328, each of which are described in further detail below.

To support future applications (e.g., IoT applications, audio applications, etc.), the PHY 328 of the present disclosure may support an increased range of communication and data rate as compared to the PHY in a traditional BLE protocol stack. The PHY 328 may define the mechanism for transmitting a bit stream over a physical link that connects BLE devices and/or peer proprietary devices. The bit stream may be grouped into code words or symbols, and converted to a PDU that is transmitted over a transmission medium. The PHY 328 may provide an electrical, mechanical, and procedural interface to the transmission medium. The shapes and properties of the electrical connectors, the frequency band used for transmission, the modulation scheme, and similar low-level parameters may be specified by the PHY 328.

The DTM 326 may allow testing of the PHY 328 by transmitting and receiving sequences of test packets. DTM 326 may be used in compliance and production-line testing without the need of going through the complete modified BLE protocol stack 300. In other words, the DTM 326 may skip the Host 304 and communicate directly with the short-range communications controller and/or the proprietary controller of the radio (e.g., see short-range communications controller 252, the proprietary controller 256, and radio 230 in FIG. 2) in an isolated manner.

The LL 322 may be responsible for low level communication over the PHY 328. The LL 322 may manage the sequence and timing of transmitted and received LL data PDUs, and using a LL protocol, communicate with other devices regarding connection parameters and data flow control. The LL 322 also provides gate keeping functionality to limit exposure and data exchange with other devices. If filtering is configured, the LL 322 may maintain a list of allowed devices and ignore all requests for data PDU exchange from devices not on the list. The LL 322 may use the HCl 320 to communicate with upper layers of the modified BLE protocol stack 300. In certain aspects, the LL 322 may be used to generate a LL data PDU and/or an empty packet (e.g., empty PDU) that may be transmitted using a LL communication link established with another BLE device and/or peer proprietary device using the LL 322.

The QLL 324 is a proprietary protocol that exists alongside the LL 322. The QLL 324 may be used to discover peer proprietary devices, and establish a secure communication channel therewith. For example, the QLL 324 may be used to establish a QLL communication link between proprietary controllers in two wireless devices, e.g., two or more Qualcomm® devices.

The proprietary controllers in peer proprietary devices may communicate with each other using allocated channels, a control protocol, attributes, and procedures.

Proprietary controllers may either establish a communication link after a standard connection at the LL 322 has been established or over an advertising bearer. Once a QLL communication link has been established at the QLL 324, the proprietary controllers of two peer proprietary devices may be able to communicate with each other using a set of dedicated channels.

Each channel exists at the point of link establishment, and a QLL establishment PDU may be sent to a peer device at any time on any channel. One channel may be used to perform service discovery. Additional channels may also be available depending on the services exposed by the peer device. Each QLL establishment PDU sent may include a channel number, a direction bit, and an opcode. The direction bit may determine if the QLL establishment PDU is an original request message or a response message. The opcode may be used to determine the operation being requested, or responded to. In certain configurations, the opcode may be followed by zero or more octets of parameters.

Each service available at a proprietary controller may be associated with a particular channel number. A proprietary controller may include up to or more than, e.g., 127 different services. The services may include, e.g., firmware updates, licensing additional codes, and/or adding additional firmware components on peer devices just to name a few. Logically, channels are not considered to be a client or a server, although in the procedural descriptions the terms client and server may be used to quickly differentiate the originator of a message sequence and the responder to the message sequence. In certain aspects, a service may be available at a proprietary controller but the service may not be currently active. For example, a service may include the ability to manage a PHY connection with a peer proprietary device but no PHY connections are currently active. Hence the management of a PHY connection is not currently active.

The opcodes of the QLL establishment PDU may be defined as one of three different types. The first type of opcode may include common opcodes that every channel supports. The common opcodes may be used to by a proprietary controller to access attributes of a peer proprietary controller. The proprietary controller that receives a QLL establishment PDU with an opcode that is unrecognized may reject the QLL establishment PDU (e.g., the proprietary controller with not response with a QLL establishment PDU). The second type of opcode may include unassigned opcodes that no channel may use, and would therefore be rejected if included in a QLL establishment PDU that is received by a proprietary controller. The third type of opcode may include channel specific opcodes that are associated with procedures that are specific to a particular channel. Channel specific opcodes may be reused by multiple channels. Each channel-specific opcode value defined by a channel may be in a separate number space than other channels and may overlap with opcodes values assigned by other channels.

Common opcodes may allow access to a number of attributes that expose simple readable and writable values that would otherwise require custom opcodes for each channel. Common opcodes may be used for reading an attribute, and for writing an attribute. Common opcodes that may be used to read and/or write an attribute may cause a response from a peer proprietary controller. In certain configurations, one request may be outstanding at any time per channel. Certain common opcodes may be used to determine the current status of a peer service, which may enable a peer proprietary device to determine if a requested service is exposed but not available, e.g., because the appropriate application software has not yet been loaded at the requesting peer proprietary device.

Attributes may be defined as one of three different types. Common attributes may exist for every service, unassigned attributes may not defined, and channel specific attributes may enable a peer proprietary device to associate a specific attribute with a specific channel. Attribute identifiers for channel specific attributes may be reused by multiple channels.

Procedures associated with the QLL 324 may be defined for both master devices and slave devices such that behavior on both sides may be documented. Each procedure may define how the master device will initiate the procedure, how the slave device responds, and when the procedure is completed. If the slave device fails to respond as expected, a global procedure response timeout may be used, at which point all communication between the peer proprietary devices may be terminated.

The QLL 324 may establish secure channels between two proprietary controllers with minimal host level support. By establishing secure channels between two proprietary controllers, communications via a QLL communication link may be independent of the hardware, firmware, host operating system, host software stacks and host application support. A secure QLL communication link between two proprietary controllers may provide services such as firmware updates, licensing additional codes, or add additional firmware components on peer devices with minimal host software support by a peer proprietary device just to name a few examples. The QLL 324 may support providing secure channels between host level components that bypasses the normal BT protocols.

The Root of Trust (RoT) 330 may provide a set functions that are always trusted by a proprietary device's operating system (OS). The RoT 330 may control a trusted computing platform cryptographic processor at a proprietary device.

QRoot key 332 may include a shared key that may be used for communication with other proprietary devices. The QRoot key 332 may be used to indicates that a device is a QLL supporting device.

The original equipment manufacturer (OEM)/App root keys 334 may include a shared key that may be used for communication with other devices that support a specific OEM or a specific App. In certain configurations, after a device is sold different functionality related to the QLL, a specific OEM, and/or a specific App may be enabled by “turning on” specific keys maintained at the QRoot key 332 and/or the OEM/App root keys 334.

The QLL security 336 may include a set of security algorithms that may be used to enable authentication of other proprietary devices based on the QRoot key 332 and/or the OEM/App keys 334.

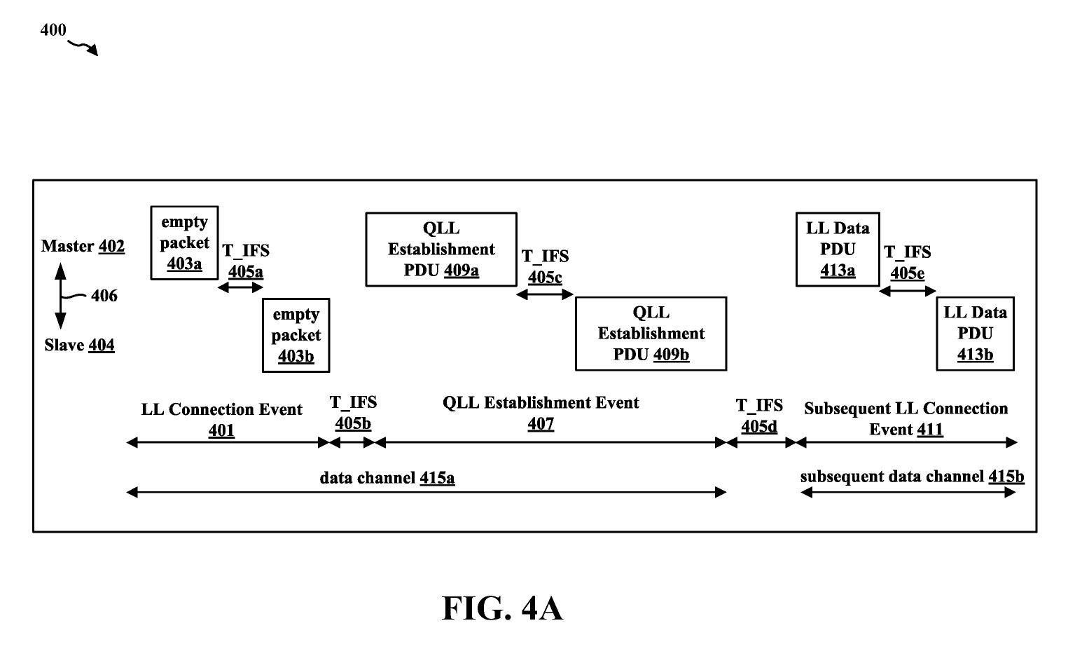

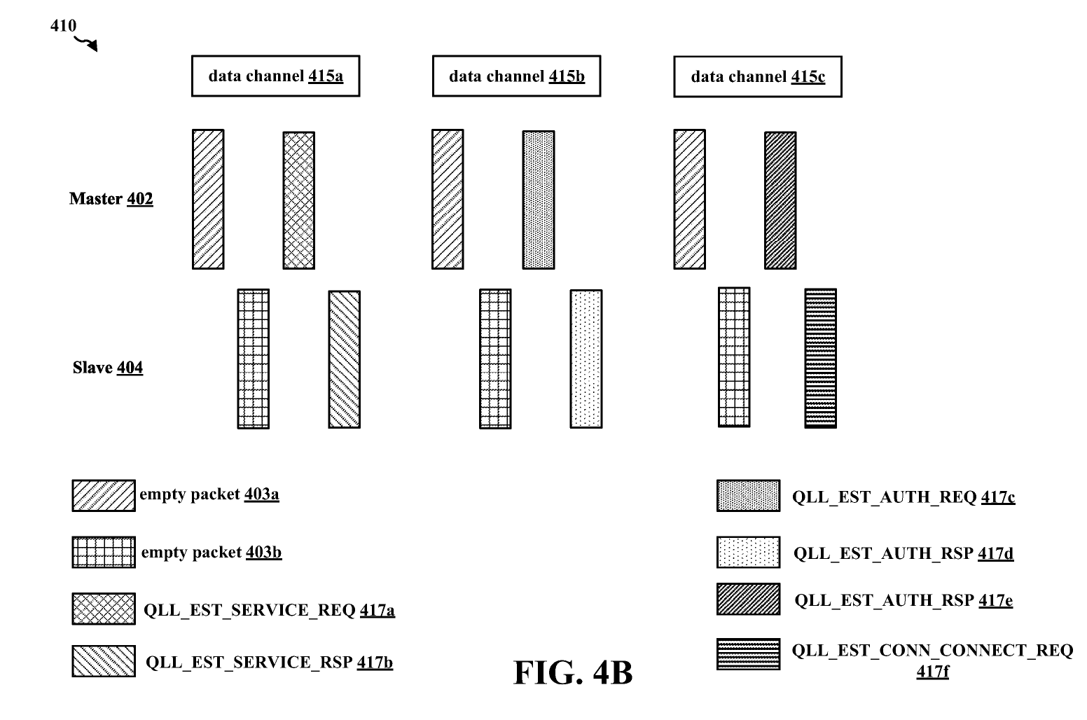

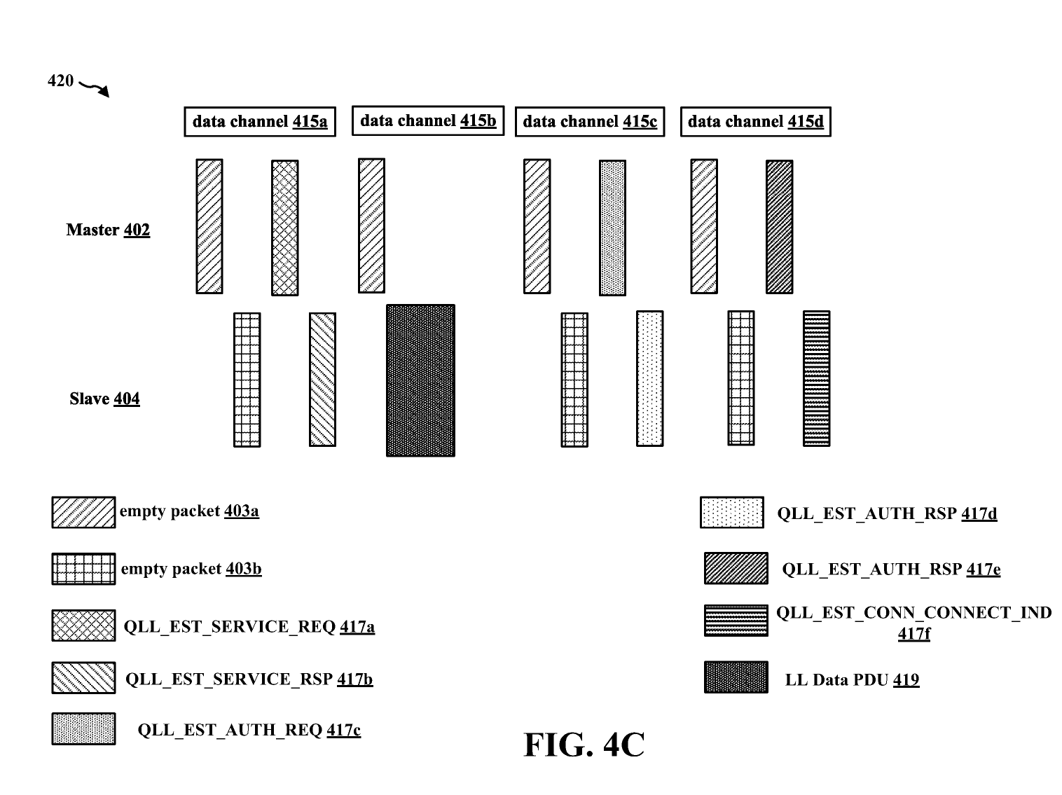

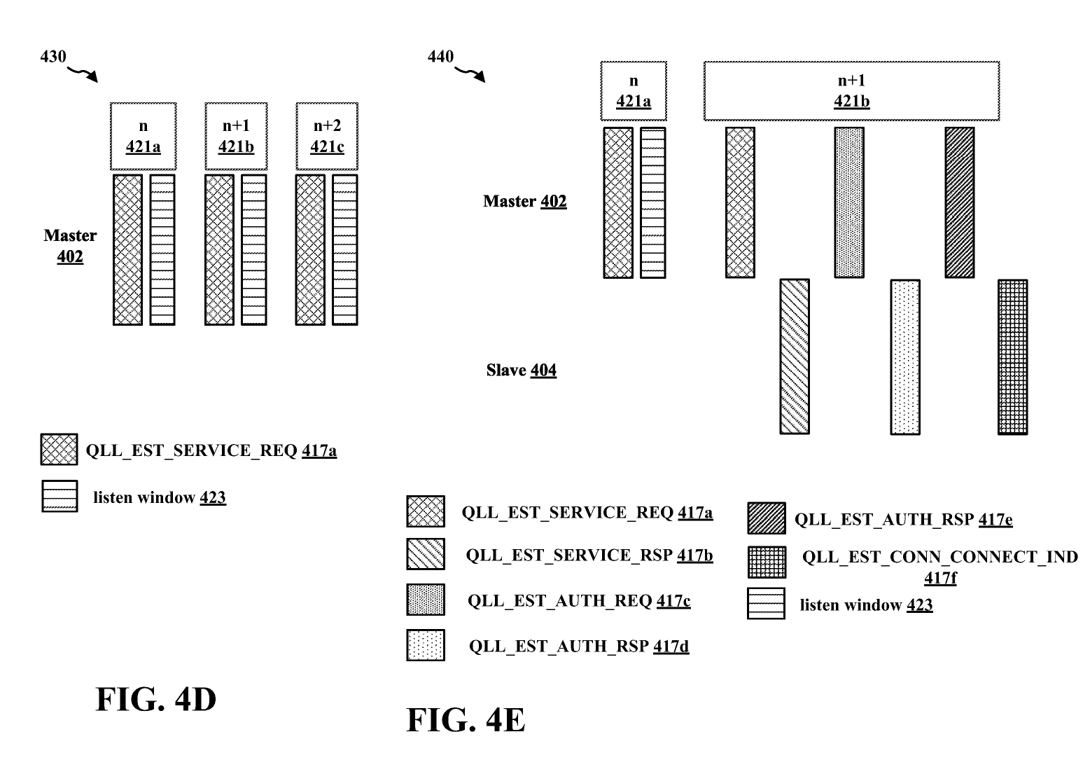

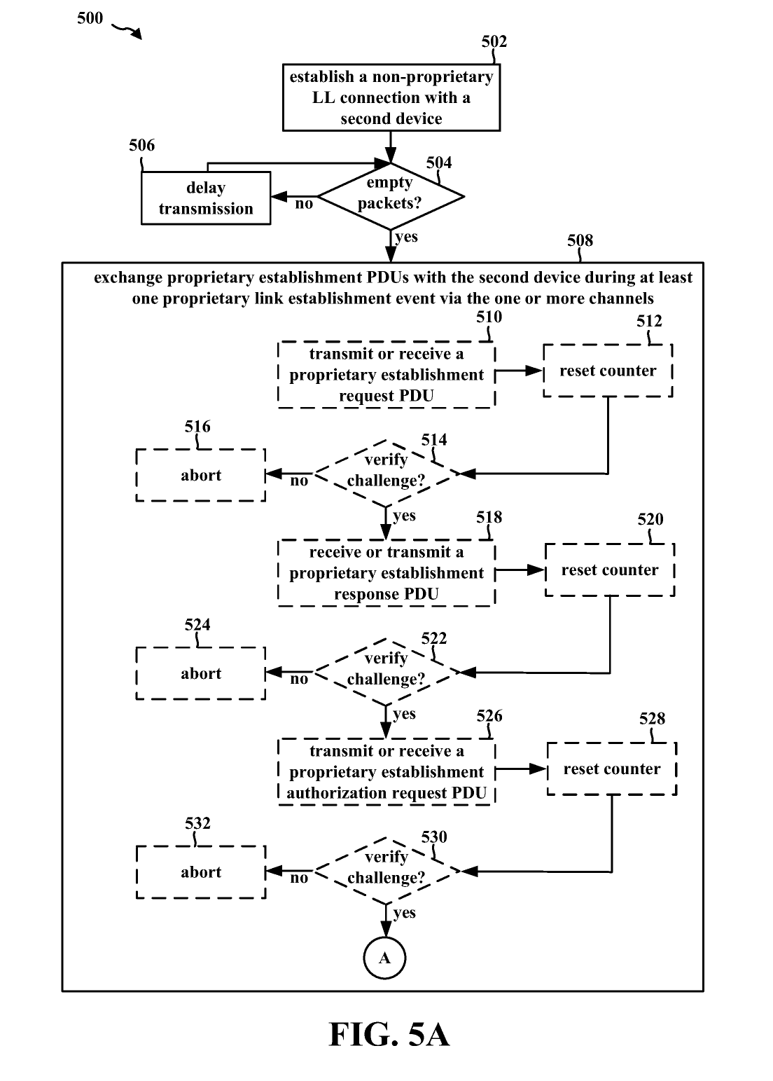

The QLL Establishment Protocol 338 may establish a QLL communication link with a peer proprietary device using a connection establishment bearer (e.g., see FIG. 4B) or an advertising establishment bearer (e.g., see FIGS. 4C and 4D).

The QLL Control Protocol 340 may serve as a QLL channel multiplexer for the QLL communication link. The QLL Control Protocol 340 may also define the QLL control PDUs and QLL control procedures used to manage the QLL logical channels. The QLL Control Protocol 340 may define a set of QLL Control PDUs available to all channels and permit each QLL channel to define channel-specific QLL Control PDUs and procedures.

All QLL communication links may support a QLL control channel (CC) 342 (e.g., channel 1). The QLL CC 342 may be used to perform QLL service discovery to identify a peer proprietary controller, determine other QLL channels, and determine QLL features supported between two proprietary controllers. The QLL CC 342 may also be used to terminate the QLL communication link.

The Controller Channels 344 (e.g., channel 2 . . . channel n) may be used to enable different functionality in the controller (e.g., short-range communication controller 252, Controller 306, etc.) to be multiplexed between two or more proprietary devices. For example, the Controller Channels 344 may enable power control updates or codec updates to be performed by an exchange of information between two or more proprietary devices using the Controller Channels 344.

The Host Channels 346 (e.g., channel n+1, channel n+2 . . . channel n+m) may be used to enable different functionality in the Host 304 to be multiplexed between two or more proprietary devices. For example, the Host Channels 344 may enable updates to host protocols (e.g., such as music channel control) to be performed by an exchange of information between two or more proprietary devices using the Host Channels 346.

The QLL HCl Extensions 348 may be used to enable communication between the Host 304 and a controller of another proprietary device.

The L2CAP 318 may encapsulate multiple protocols from the upper layers into a LL data PDU and/or a QLL establishment PDU (and vice versa). The L2CAP 318 may also break large LL data PDUs and/or a QLL establishment PDUs from the upper layers into segments that fit into a maximum payload size (e.g., 27 bytes) on the transmit side. Similarly, the L2CAP 318 may receive multiple LL data PDUs and/or a QLL establishment PDUs that have been segmented, and the L2CAP 318 may combine the segments into a single LL data PDU and/or a QLL establishment PDU that may be sent to the upper layers.

The ATT 316 may be a client/server protocol based on attributes associated with a BLE device configured for a particular purpose (e.g., monitoring heart rate, temperature, broadcasting advertisements, etc.). The attributes may be discovered, read, and written by peer proprietary devices. The set of operations which are executed over ATT 316 may include, but are not limited to, error handling, server configuration, find information, read operations, write operations, queued writes, etc. The ATT 316 may form the basis of data exchange between BLE devices and/or peer proprietary devices.

The SM 314 may be responsible for device pairing and key distribution. A security manager protocol implemented by the SM 314 may define how communications with the SM of a peer proprietary device and/or counterpart BLE deice are performed. The SM 314 may provide additional cryptographic functions that may be used by other components of the modified BLE protocol stack 300. The architecture of the SM 314 used in BLE may be designed to minimize recourse requirements for peripheral devices by shifting work to a central device. BLE uses a pairing mechanism for key distribution. The SM 314 provides a mechanism to not only encrypt the data but also to provide data authentication.

The GATT 312 describes a service framework using the attribute protocol for discovering services, and for reading and writing characteristic values on a peer proprietary device and/or counterpart BLE device. The GATT 312 interfaces with the App 308 through the App's profile. The App 308 profile defines the collection of attributes and any permission needed for the attributes to be used in BLE communications. One of the main benefits of BT technology is device interoperability. To assure interoperability, using a standardized wireless protocol to transfer bytes of information may be inadequate, and hence, sharing data representation levels may be needed. In other words, both devices may send or receive data in the same format using the same data interpretation based on intended device functionality. The profile is a bridge between the modified BLE protocol stack and the application and functionality of the BLE device (e.g., at least from a wireless connection point of view), and is defined by the profile.

The GAP 310 may provide an interface for the App 308 to initiate, establish, and manage connection with other BLE devices and/or peer proprietary devices.

BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. A BLE communications link between two devices may established using, e.g., hardware, firmware, host operating system, host software stacks, and/or host application support. Example applications that use BLE include battery-operated sensors and actuators in various medical, industrial, consumer, and fitness applications that connect to devices such as BLE enabled smart phones, tablets, and laptops. While traditional BLE offers certain advantages, there exists a need for further improvements in BLE technology.

For example, in certain scenarios, establishing a QLL communication link between two proprietary devices that is independent of the hardware, firmware, host operating system, host software stacks, and/or host application support may be beneficial. By establishing a QLL communication link that is independent of the hardware, firmware, host operating system, host software stacks, and/or host application support, services such as firmware updates, licensing additional codes, and/or adding additional firmware components on peer devices with minimal peer host software support may be supported.

Thus, there exists a need for a technique to establish a QLL connection between two proprietary devices that is independent of the hardware, firmware, host operating system, host software stacks, and/or host application support.

The present disclosure provides a QLL protocol that exists alongside of the Link Layer (LL) in the BLE protocol stack. The QLL protocol may be used to discover other proprietary devices. The QLL protocol may also be used to establish a secure QLL communication link with another proprietary device that is independent of the hardware, firmware, host operating system, host software stacks, and/or host application support in order to support services such as firmware updates, licensing additional codes, and/or adding additional firmware components.

FIG. 4A illustrates a data flow 400 that may be used to establish a QLL communication link in accordance with certain aspects of the disclosure. The QLL communication link may be between a master device 402 and a slave device 404. In certain aspects, the master device 402 and the slave device 404 may be BLE enabled devices. In certain other aspects, the master device 402 and the slave device 404 may be peer proprietary devices associated with the same company. The master device 402 may correspond to, e.g., central device 102, wireless device 200, the apparatus 602/602′, 902/902′. The slave device 404 may correspond to, e.g., peripheral device 104, 106, 108, 110, 112, 114, wireless device 200, the second device 650, 950.

The master device 402 and the slave device 404 may establish a LL connection 406. The master device 402 may transmit an empty packet 403a to the slave device 404 during a LL connection event 401 when the master device 402 does not have a LL data PDU to transmit to the slave device 404. The slave device 404 may respond with an empty packet 403b that is transmitted at a predetermined time (e.g., T_IFS 405a) after the transmission of the empty packet 403a. The slave device 404 may respond with the empty packet 403a when the slave device 404 does not have a LL data PDU to transmit to the master device 402.

When the LL connection is established, the master device 402 and the slave device 404 may initially be in a default QLL standby state. The master device 402 and the slave device 404 may not send or receive QLL PDUs in the QLL standby state. The master device 402 and the slave device 404 may leave the QLL standby state to enter the QLL establishing state when a LL connection is established between the master device 402 and the slave device 404. The master device 402 may enter the QLL establishing state when the proprietary controller at the master device 402 wants to establish a QLL link with the proprietary controller of the slave device 404.

A QLL establishment event 407 may begin a predetermined time (e.g., T_IFS 405b) after the end of the LL connection event 401. The master device 402 may transmit a QLL establishment PDU 409a to the slave device 404. The slave device 404 may respond with a QLL establishment PDU 409b that is sent at a predetermined time (e.g., T_IFS 405c) after the transmission of the QLL establishment PDU 409a.

The QLL establishment event 407 may use the same data channel 415a that is used for the exchange of the empty packets 403a, 403b during the LL connection event 401. In certain aspects, more than one QLL establishment event may be required to establish the QLL communication link. In other words, a predetermined series of QLL establishment PDUs may be exchanged before the QLL communication link is established, and one or more of the QLL establishment PDUs may be exchanged during different QLL establishment events. In certain configurations, QLL establishment events may occur whether or not any QLL establishment PDUs are transmitted.

The QLL establishment event 407 may end when the last QLL establishment PDU 409b is sent or after a predetermined time period. A subsequent LL connection event 411 may begin at a predetermined time (e.g., T_IFS 405d) after the end of the QLL establishment event 407. The subsequent LL connection event 411 may use a subsequent data channel 415b. In certain configurations, the subsequent data channel 415b may be a different data channel than data channel 415a. In certain other configurations, the subsequent data channel 415b may be the same as data channel 415a.

As illustrated in FIG. 4A, the master device 402 may transmit a LL data PDU 413a to the slave device 404 (e.g., when the master device 402 has a LL data PDU 413a to transmit to the slave device 404). The slave device 404 may respond by sending a LL data PDU 413b a predetermined time (e.g., T_IFS 405e) after the transmission of the LL data PDU 413a when the slave device 404 has a LL data PDU 413b to send to the master device 402. Because LL data PDUs 413a, 413b are transmitted during the subsequent LL connection event 411, a subsequent QLL establishment PDU (not shown in FIG. 4A) that occurs in the subsequent data channel 415b may not be transmitted T IFS after the end of the subsequent LL connection event 411. Instead, the exchange of subsequent QLL establishment PDUs be delayed until after another set of empty packets are transmitted in a LL connection event. QLL establishment PDUs may not be exchanged on the same channel used to communicate LL data PDUs because QLL establishment PDUs may include an extended opcode that are not included in LL data PDUs. Hence, a different mechanism and/or channel may be used to communicate QLL establishment PDUs.

QLL establishment timeout may occur when a predetermined number of QLL establishment events have occurred without receiving a proper response to a QLL establishment protocol procedure. For example, QLL establishment PDUs may be received in the proper sequence prior to QLL establishment timeout or the establishment is considered failed and the QLL establishment procedure may be aborted. The QLL establishment timeout may be reset to a count of zero after a proper QLL establishment PDU in the sequence is received. The QLL establishment protocol may include the exchange of a particular sequence of QLL establishment PDUs. Additional details associated with the QLL establishment protocol and the particular sequence of QLL establishment PDUs are discussed below with respect to FIGS. 4B and 4C.

FIG. 4B illustrates a QLL establishment protocol 410 used to establish a QLL communication link by exchanging a particular sequence of QLL establishment PDUs in accordance with certain aspects of the disclosure. The QLL establishment protocol 410 may be performed by the master device 402 and the slave device 404 discussed above with reference to FIG. 4A. In certain configurations, the QLL establishment protocol 410 may be performed after a LL connection (e.g., a connection establishment bearer) is established between the master device 402 and the slave device 404.

The QLL establishment protocol 410 may include the exchange of a particular sequence of QLL establishment PDUs. For example, a QLL establishment PDU may be received in the proper sequence prior to the QLL establishment timeout. Otherwise the establishment may be considered failed, and the QLL establishment procedure may be aborted. Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter. If the QLL establishment procedure is aborted, the proprietary controllers may return to the QLL standby state discussed above with reference to FIG. 4A.

The proper sequence of QLL establishment PDUs in the QLL establishment protocol 410 may include the following: 1) QLL_EST_SERVICE_REQ 417a sent by the master device 402, 2) QLL_EST_SERVICE_RSP 417b sent by the slave device 404, 3) QLL_EST_AUTH_REQ 417c sent by the master device 402, 4) a first QLL_EST_AUTH_RSP 417d sent by the slave device 404, 5) a second QLL_EST_AUTH_RSP 417e sent by the master device 402, and 6) QLL_EST_CONN_CONNECT_IND 417f sent by the slave device 404.

In certain configurations, each of the QLL establishment PDUs 417a, 417b, 417c, 417d, 417e, 417f may include a challenge that is verified by the receiving proprietary device before a response is transmitted in the QLL establishment event or a subsequent QLL establishment event. For example, the challenge may include a single hash of two random numbers to be contributed by both the receiving proprietary device and the transmitting proprietary device and the QRoot key the devices are authenticating against. When a challenge cannot be verified based on the hash and/or the QRoot key, the subsequent QLL establishment PDU may not be transmitted and the QLL establishment protocol 410 may be aborted. If the QLL establishment protocol is aborted, the proprietary device may return to the QLL standby state.

Referring to FIG. 4B, a first LL connection event and a first QLL establishment event may occur using a first data channel 415a. During the first LL connection event on the first data channel 415a, the master device 402 and the slave device 404 may exchange empty packets 403a, 403b. During the first QLL establishment event on the first data channel 415a, the master device 402 may transmit the QLL_EST_SERVICE_REQ 417a and the slave device 404 may transmit the QLL_EST_SERVICE_RSP 417b. For example, when the slave device 404 receives the QLL_EST_SERVICE_REQ 417a, the slave device 404 may respond in the same QLL establishment event or the next QLL establishment event with a QLL_EST_SERVICE_RSP 417b on the same data channel when a challenge included in the QLL_EST _SERVICE_REQ 417a can be verified by the slave device 404.

The QLL EST SERVICE RSP 417b may include a challenge that the master device 402 may verify before sending the next QLL establishment PDU in the QLL establishment protocol 410.

In certain implementations, a second LL connection event and a second QLL establishment event may occur on a second data channel 415b. During the second LL connection event on the second data channel 415b, the master device 402 and the slave device 404 may exchange empty packets 403a, 403b. During the second QLL establishment event on the second data channel 415b, the master device 402 may transmit the QLL_EST_AUTH_REQ 417c and the slave device 404 may transmit the QLL_EST_AUTH_RSP 417d.

In certain configurations, the QLL_EST_AUTH_REQ 417c may include a challenge that the slave device 404 may verify before transmitting the QLL_EST_AUTH_RSP 417d. In certain other configurations, the first QLL_EST_AUTH_RSP 417d may include a challenge that the master device 402 may verify before sending the next QLL establishment PDU in the QLL establishment protocol 410.

In certain other implementations, a third LL connection event and a third QLL establishment event may occur on a third data channel 415c. During the third LL connection event on the third data channel 415c, the master device 402 and the slave device 404 may exchange empty packets 403a, 403b. During the third QLL establishment event on the third data channel 415c, the master device 402 may transmit the QLL_EST_AUTH_RSP 417e and the slave device 404 may transmit the QLL_EST_CONN_CONNECT_IND 417f.

In certain configurations, the QLL_EST_AUTH_RSP 417e may include a challenge that the slave device 404 may verify before transmitting the QLL_EST_CONN_CONNECT_IND 417f In certain other configurations, the QLL_EST_CONN_CONNECT_IND 417f may include a challenge that the master device 402 may verify before the QLL communication link is established between the master device 402 and the slave device 404.

FIG. 4C illustrates a QLL establishment protocol 420 used to establish a QLL communication link by exchanging a particular sequence of QLL establishment PDUs in accordance with certain aspects of the disclosure. The QLL establishment protocol 420 may be performed by the master device 402 and the slave device 404 discussed above with reference to FIGS. 4A and/or 4B. The QLL establishment protocol 420 may include the same sequence of QLL establishment PDUs as the QLL establishment protocol 410 discussed above with reference to FIG. 4B. However, the QLL establishment protocol 420 illustrated in FIG. 4B depicts a LL data PDU transmitted during a LL connection event rather than an empty packet.

The proper sequence of QLL establishment PDUs in the QLL establishment protocol 420 may be the following: 1) QLL_EST_SERVICE_REQ 417a sent by the master device 402, 2) QLL_EST_SERVICE_RSP 417b sent by the slave device 404, 3) QLL_EST_AUTH_REQ 417c sent by the master device 402, 4) QLL_EST_AUTH_RSP 417d sent by the slave device 404, 5) QLL_EST_AUTH_RSP 417e sent by the master device 402, and 6) QLL_EST_CONN_CONNECT_IND 417f sent by the slave device 404.

Referring to FIG. 4C, a first LL connection event and a first QLL establishment event may occur using a first data channel 415a. During the first LL connection event on the first data channel 415a, the master device 402 and the slave device 404 may exchange empty packets 403a, 403b. During the first QLL establishment event on the first data channel 415a, the master device 402 may transmit the QLL_EST_SERVICE_REQ 417a and the slave device 404 may transmit the QLL_EST SERVICE_RSP 417b.

The QLL_EST_SERVICE_RSP 417b may include a challenge that the master device 402 may verify before sending the next QLL establishment PDU in the QLL establishment protocol 410.

In certain implementations, a second LL connection event and a second QLL establishment event may occur on a second data channel 415b. During the second LL connection even on the second data channel 415b, the master device 402 may transmit an empty packet 403a and the slave device 404 may have a LL data PDU 419 available to be transmitted to the master device 402 instead of an empty packet. Because a LL data PDU 419 is transmitted during the second LL connection event, no QLL establishment PDUs are transmitted during the second QLL establishment event on the second data channel 415b. Hence, the master device 402 delays the transmission of the QLL_EST_AUTH_REQ 417c until a subsequent QLL establishment event that follows a LL connection event during which a LL data PDU is not transmitted by either the master device 402 or the slave device 404.

In certain other implementations, a third LL connection event and a third QLL establishment event may occur on a third data channel 415c. During the third LL connection even on the third data channel 415c, the master device 402 and the slave device 404 may exchange empty packets 403a, 403b. During the third QLL establishment event on the third data channel 415c, the master device 402 may transmit the QLL_EST_AUTH_REQ 417c and the slave device 404 may transmit the QLL_EST_AUTH_RSP 417d.

In certain configurations, the QLL_EST_AUTH_REQ 417c may include a challenge that the slave device 404 may verify before transmitting the QLL_EST_AUTH_RSP 417d. In certain other configurations, the QLL_EST_AUTH_RSP 417d may include a challenge that the master device 402 may verify before sending the next QLL establishment PDU in the QLL establishment protocol 410.

In certain other implementations, a fourth LL connection event and a fourth QLL establishment event may occur on a fourth data channel 415d. During the fourth LL connection even on the fourth data channel 415d, the master device 402 and the slave device 404 may exchange empty packets 403a, 403b. During the fourth QLL establishment event on the fourth data channel 415d, the master device 402 may transmit the QLL_EST_AUTH_RSP 417e and the slave device 404 may transmit the QLL_EST_CONN_CONNECT_IND 417f.

In certain configurations, the QLL_EST_AUTH_RSP 417e may include a challenge that the slave device 404 may verify before transmitting the QLL_EST_CONN_CONNECT_IND 417f . In certain other configurations, the QLL_EST_CONN_CONNECT_IND 417f may include a challenge that the master device 402 may verify before the QLL communication link is established between the master device 402 and the slave device 404. Once the QLL_EST_CONN_CONNECT_IND 417f has been received by the master device 402, the QLL communication link may be established between the master device 402 and the slave device 404.

FIG. 4D illustrates an initiation of a QLL establishment protocol 430 used to establish a QLL communication link over an advertising establishment bearer in accordance with certain aspects of the disclosure. The QLL establishment protocol may be performed by the master device 402 and the slave device 404 discussed above with reference to FIGS. 4A-4C. Although three advertising channels are illustrated in FIG. 4D, fewer than three advertising channels or more than three advertising bearer channels may be used without departing from the scope of the present disclosure.

Referring to FIG. 4D, the master device 402 may initiate a QLL establishment protocol 430 by transmitting the QLL_EST_SERVICE_REQ 417a on each of the advertising channels (e.g., channel n 421a, channel n+1 421b, channel n+2 421c). The master device 402 may then use a listening window 423 that is located a predetermined time (e.g., T_ISF) after the transmission of QLL_EST_SERVICE_REQ 417a in the time domain to determine on which of the advertising bearer channels the slave device responds.

FIG. 4E illustrates a QLL establishment protocol 440 used to establish a QLL communication link over an advertising establishment bearer in accordance with certain aspects of the disclosure. The QLL establishment protocol may be performed by the master device 402 and the slave device 404 discussed above with reference to FIGS. 4A-4D. Although two advertising channels are illustrated in FIG. 4E, a single advertising channel or more than two advertising channels may be used without departing from the scope of the present disclosure.

The proper sequence of the QLL establishment protocol 440 may be the following:

1) QLL_EST_SERVICE_REQ 417a sent by the master device 402, 2) QLL_EST_SERVICE_RSP 417b sent by the slave device 404, 3) QLL_EST_AUTH_REQ 417c sent by the master device 402, 4) QLL_EST_AUTH_RSP 417d sent by the slave device 404, 5) QLL_EST_AUTH_RSP 417e sent by the master device 402, and 6) QLL_EST_CONN_CONNECT_IND 417f sent by the slave device 404.

Referring to FIG. 4E, the master device 402 initiates the QLL establishment protocol 440 by transmitting the QLL_EST_SERVICE_REQ 417a on all of the advertising channels (e.g., channel n 421a and channel n+1 421b). The QLL establishment PDUs may be transmitted over the advertising channels 421a, 421b in a non-connectable advertising packet using a specially formatted advertising payload. After sending the QLL_EST_SERVICE_REQ 417a, the master device 402 may listen for a response from the slave device 404 in the listening window 423 on each of the advertising channels 421a, 421b. The master device 402 and the slave device may exchange subsequent QLL establishment PDUs 417b, 417c, 417d, 417e, 417f on one of the advertising channels 421a, 421b. Once the QLL establishment PDUs 417a, 417b, 417c, 417d, 417e, 417f have been exchanged, a QLL communication link between the master device 402 and the slave device 404 may be established. Communications between the master device 402 and the slave device 404 may occur via the QLL communication link. For example, communications via the QLL communication link may include proprietary firmware updates, proprietary licensing of additional codes, and/or adding additional proprietary firmware components just to name a few.

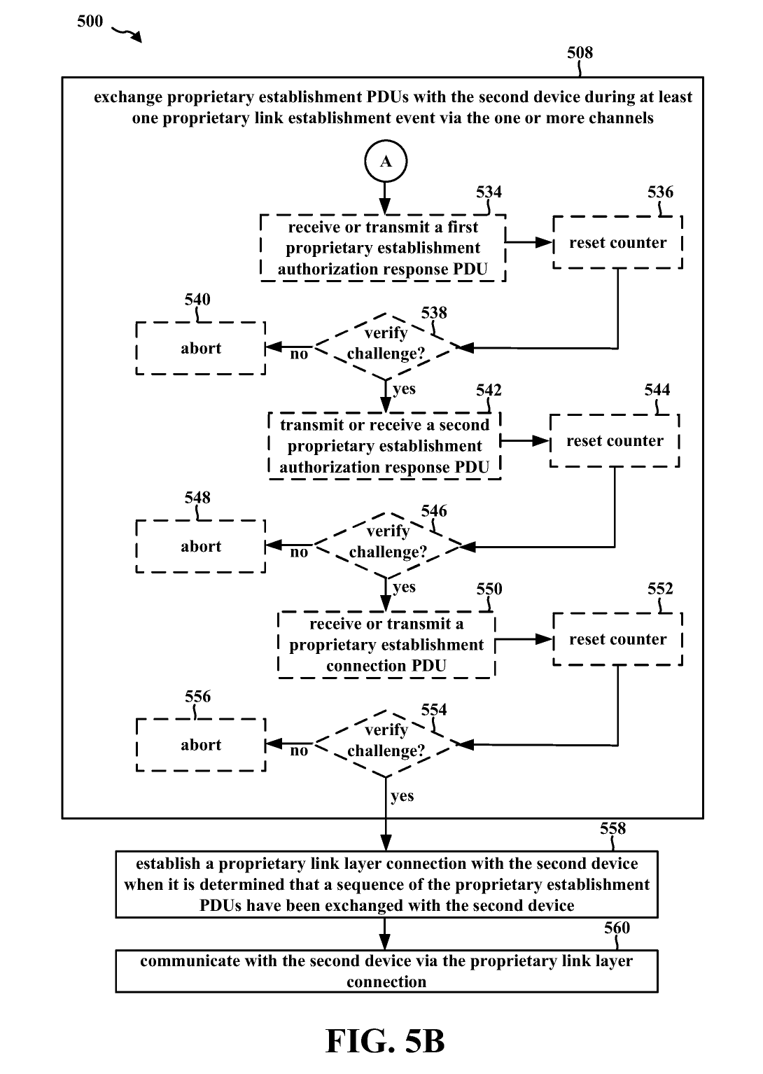

FIGS. 5A and 5B are a flowchart 500 of a method of wireless communication. The method may be performed by a first device (e.g., central device 102, peripheral device 104, 106, 108, 110, 112, 114, wireless device 200, master device 402, slave device 404, the apparatus 602/602′, 902/902′, the second device) in communication with a second device (e.g., central device 102, peripheral device 104, 106, 108, 110, 112, 114, wireless device 200, master device 402, slave device 404, the apparatus 602/602′, 902/902′, the second device 650). In FIGS. 5A and 5B, optional operations are indicated with dashed lines.

Referring to FIG. 5A, at 502, the first device may establish a non-proprietary link layer connection with a second device. For example, referring to FIG. 4A, the master device 402 and the slave device 404 may establish a LL connection 406.

At 504, the first device may determine if a first set of empty non-proprietary link layer PDUs are exchanged with the second device via one or more channels during a non-proprietary link layer connection event. For example, referring to FIG. 4A, the master device 402 may determine if empty packets are transmitted during the LL connection event 401. For example, the master device 402 may transmit an empty packet 403a to the slave device 404 during a LL connection event 401 when the master device 402 does not have a LL data PDU to transmit to the slave device 404. The slave device 404 may respond with an empty packet 403b that is transmitted at a predetermined time (e.g., T_IFS 405a) after the transmission of the empty packet 403a. The slave device 404 may respond with the empty packet 403a when the slave device 404 does not have a LL data PDU to transmit to the master device 402.

If (at 504) the first device determines that a first set of empty non-proprietary link layer PDUs are not transmitted (e.g., in other words an LL data PDU is transmitted), then the operation may move to 506. Conversely, if (at 504) the first device determines that a first set of empty non-proprietary link layer PDUs are transmitted (e.g., in other words an LL data PDU is not transmitted), then the operation may move to 508.

At 506, the first device may delay the transmission of a proprietary establishment PDU until a set of empty non-proprietary PDUs are transmitted during a link layer connection event. For example, referring to FIG. 4A, because LL data PDUs 413a, 413b are transmitted during the subsequent LL connection event 411, a subsequent QLL establishment PDU (not shown in FIG. 4A) that occurs in the subsequent data channel 415b may not be transmitted T_IFS after the end of the subsequent LL connection event 411. Instead, the exchange of subsequent QLL establishment PDUs may be delayed until after another set of empty packets are transmitted in a LL connection event.

At 508, the first device may exchange proprietary establishment PDUs with the second device during at least one proprietary link establishment event via the one or more channels when it is determined that the first set of empty non-proprietary link layer PDUs are exchanged with the second device via the one or more channels. For example, referring to FIG. 4A, The master device 402 may transmit a QLL establishment PDU 409a to the slave device 404. The slave device 404 may respond with a QLL establishment PDU 409b that is sent at a predetermined time (e.g., T_IFS 405c) after the transmission of the QLL establishment PDU 409a that is received by the master device.

At 510, the first device may exchange proprietary establishment PDUs with the second device during at least one proprietary link establishment event via the one or more channels by transmitting or receiving a proprietary establishment request PDU. For example, referring to FIG. 4B, the master device 402 may transmit the QLL_EST_SERVICE_REQ 417a that is received by the slave device 404. When the first device is the master device 402, the first device transmits the QLL_EST_SERVICE_REQ 417a. Alternatively, when the first device is the slave device 404, the first device receives QLL_EST_SERVICE_REQ 417a.

When the first device is a slave device, the operation may move to 512. When the first device is a master device, the operation may move to 518.

At 512, the first device may reset a counter each time a proprietary establishment PDU is received before an end of a timeout duration. For example, referring to FIG. 4B, Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter.

At 514, when the first device is the slave device, the first device may verify if a challenge included in the proprietary establishment request PDU can be verified. For example, referring to FIG. 4B, when the slave device 404 receives the QLL_EST_SERVICE_REQ 417a, the slave device 404 may respond in the same QLL establishment event or the next QLL establishment event with a QLL_EST_SERVICE_RSP 417b on the same data channel when a challenge included in the QLL_EST_SERVICE_REQ 417a can be verified by the slave device 404.

If (at 514) the challenge cannot be verified, the operation moves to 516. If (at 514) the challenge can be verified, the operation moves to 518.

At 516, the first device may abort the exchange of proprietary establishment PDUs with the second device. For example, referring to FIG. 4B, each of the QLL establishment PDUs 417a, 417b, 417c, 417d, 417e, 417f may include a challenge that is verified by the receiving proprietary device before a response is transmitted in the QLL establishment event or a subsequent QLL establishment event. When a challenge cannot be verified, the subsequent QLL establishment PDU may not be transmitted and the QLL establishment protocol 410 may be aborted. If the QLL establishment protocol is aborted, the proprietary device may return to the QLL standby state.

At 518, the first device may receive or transmit a proprietary establishment response

PDU. For example, referring to FIG. 4B, during the first QLL establishment event on the first data channel 415a, the slave device 404 may transmit the QLL_EST_SERVICE_RSP 417b that is received by the master device 402. When the first device is a master device, the first device may receive the QLL_EST_SERVICE_RSP 417b. When the first device is a slave device, the first device may transmit the QLL_EST_SERVICE_RSP 417b.

When the first device is a master device, the operation may move to 520. When the first device is a slave device, the operation may move to 526.

At 520, the first device may reset a counter each time a proprietary establishment PDU is received before an end of a timeout duration. For example, referring to FIG. 4B, Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter.

At 522, when the first device is a master device, the first device may verify if a challenge included in the proprietary establishment response PDU can be verified. For example, referring to FIG. 4B, the QLL_EST_SERVICE_RSP 417b may include a challenge that the master device 402 may verify before sending the next QLL establishment PDU in the QLL establishment protocol 410.

If (at 522) the challenge cannot be verified, the operation moves to 524. If (at 522) the challenge can be verified, the operation moves to 526.

At 524, the first device may abort the exchange of proprietary establishment PDUs with the second device. For example, referring to FIG. 4B, each of the QLL establishment PDUs 417a, 417b, 417c, 417d, 417e, 417f may include a challenge that is verified by the receiving proprietary device before a response is transmitted in the QLL establishment event or a subsequent QLL establishment event. When a challenge cannot be verified, the subsequent QLL establishment PDU may not be transmitted and the QLL establishment protocol 410 may be aborted. If the QLL establishment protocol is aborted, the proprietary device may return to the QLL standby state.

At 526, the first device may transmit or receive a proprietary establishment authorization request PDU. For example, referring to FIG. 4B, the master device 402 may transmit the QLL_EST_AUTH_REQ 417c that is received by the slave device 404. When the first device is a master device, the first device may transmit the QLL_EST_AUTH_REQ 417c. Alternatively, when the first device is a slave device, the first device may receive the QLL_EST_AUTH_REQ 417c.

When the first device is a slave device, the operation may move to 528. When the first device is a slave device, the operation may move to 534 as seen in FIG. 5B.

At 528, the first device may reset a counter each time a proprietary establishment PDU is received before an end of a timeout duration. For example, referring to FIG. 4B, Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter.

At 530, when the first device is a slave device, the first device may determine if a challenge included in the proprietary establishment authorization request PDU can be verified. For example, referring to FIG. 4B, the QLL_EST_AUTH_REQ 417c may include a challenge that the slave device 404 may verify before transmitting the QLL_EST_AUTH_RSP 417d.

If (at 530) the challenge cannot be verified, the operation moves to 532. If (at 530) the challenge can be verified, the operation moves to 534 seen in FIG. 5B.

At 532, the first device may abort the exchange of proprietary establishment PDUs with the second device. For example, referring to FIG. 4B, each of the QLL establishment PDUs 417a, 417b, 417c, 417d, 417e, 417f may include a challenge that is verified by the receiving proprietary device before a response is transmitted in the QLL establishment event or a subsequent QLL establishment event. When a challenge cannot be verified, the subsequent QLL establishment PDU may not be transmitted and the QLL establishment protocol 410 may be aborted. If the QLL establishment protocol is aborted, the proprietary device may return to the QLL standby state.

As seen in FIG. 5B, at 534, the first device may receive or transmit a first proprietary establishment authorization response PDU. For example, referring to FIG. 4B, the slave device 404 may transmit the QLL_EST_AUTH_RSP 417d that is received by the master device 402. When the first device is a slave device, the first device transmits the QLL_EST_AUTH_RSP 417d. Alternatively, when the first device is a master device, the first device receives the QLL_EST_AUTH_RSP 417d.

When the first device is a master device, the operation may move to 536. When the first device is a master device, the operation may move to 542.

At 536, the first device may reset a counter each time a proprietary establishment PDU is received before an end of a timeout duration. For example, referring to FIG. 4B, Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter.

At 538, when the first device is a master device, the first device may determine if a challenge included in the first proprietary establishment authorization response PDU can be verified. For example, referring to FIG. 4B, the first QLL_EST_AUTH_RSP 417d may include a challenge that the master device 402 may verify before sending the next QLL establishment PDU in the QLL establishment protocol 410.

If (at 538) the challenge cannot be verified, the operation moves to 540. If (at 538) the challenge can be verified, the operation moves to 542.

At 540, the first device may abort the exchange of proprietary establishment PDUs with the second device. For example, referring to FIG. 4B, each of the QLL establishment PDUs 417a, 417b, 417c, 417d, 417e, 417f may include a challenge that is verified by the receiving proprietary device before a response is transmitted in the QLL establishment event or a subsequent QLL establishment event. When a challenge cannot be verified, the subsequent QLL establishment PDU may not be transmitted and the QLL establishment protocol 410 may be aborted. If the QLL establishment protocol is aborted, the proprietary device may return to the QLL standby state.

At 542, the first device may transmit or receive a second proprietary establishment authorization response PDU. For example, referring to FIG. 4B, the master device 402 may transmit the second QLL_EST_AUTH RSP 417e that is received by the slave device 404. When the first device is a master device, the first device transmits the second QLL_EST_AUTH_RSP 417e. Alternatively, when the first device is a slave device, the first device receives the second QLL_EST_AUTH_RSP 417e.

When the first device is a slave device, the operation may move to 544. When the first device is a master device, the operation may move to 550.

At 544, the first device may reset a counter each time a proprietary establishment PDU is received before an end of a timeout duration. For example, referring to FIG. 4B, Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter.

At 546, when the first device is a slave device, the first device may determine if a challenge included in the second proprietary establishment authorization response PDU can be verified. For example, referring to FIG. 4B, the second QLL_EST_AUTH_RSP 417e may include a challenge that the slave device 404 may verify before transmitting the QLL_EST_CONN_CONNECT_IND 417f.

If (at 546) the challenge cannot be verified, the operation moves to 548. If (at 546) the challenge can be verified, the operation moves to 550.

At 548, the first device may abort the exchange of proprietary establishment PDUs with the second device. For example, referring to FIG. 4B, each of the QLL establishment PDUs 417a, 417b, 417c, 417d, 417e, 417f may include a challenge that is verified by the receiving proprietary device before a response is transmitted in the QLL establishment event or a subsequent QLL establishment event. When a challenge cannot be verified, the subsequent QLL establishment PDU may not be transmitted and the QLL establishment protocol 410 may be aborted. If the QLL establishment protocol is aborted, the proprietary device may return to the QLL standby state.

At 550, the first device may receive or transmit a proprietary establishment connection

PDU. For example, referring to FIG. 4B, the slave device 404 may transmit the QLL_EST_CONN_CONNECT_IND 417f that is received by the master device 402. When the first device is a slave device, the first device may transmit the QLL_EST_CONN_CONNECT_IND 417f. Alternatively, when the first device is a master device, the first device may receive the QLL_EST_CONN_CONNECT_IND 417f.

When the first device is a master device, the operation may move to 552. When the first device is a slave device, the operation may move to 558.

At 552, the first device may reset a counter each time a proprietary establishment PDU is received before an end of a timeout duration. For example, referring to FIG. 4B, Once a QLL establishment PDU is received in the proper sequence by either the proprietary controller in the master device 402 or the proprietary controller in the slave device 404, the establishment timeout counter (e.g., located at or in communication with the proprietary controller) is reset. QLL establishment PDUs received out-of-sequence may be ignored by a proprietary controller. When a QLL establishment PDU is received out-of-sequence, the receiving proprietary controller may not reset the establishment timeout counter.

At 554, when the first device is a master device, the first device may determine if a challenge included in proprietary establishment connection PDU can be verified. For example, referring to FIG. 4B, the QLL_EST_CONN_CONNECT_IND 417f may include a challenge that the master device 402 may verify before the QLL communication link is established between the master device 402 and the slave device 404.

If (at 554) the challenge cannot be verified, the operation moves to 556. If (at 554) the challenge can be verified, the operation moves to 558.

At 556, the first device may abort the exchange of proprietary establishment PDUs with the second device. For example, referring to FIG. 4B, each of the QLL establishment PDUs 417a, 417b, 417c, 417d, 417e, 417f may include a challenge that is verified by the receiving proprietary device before a response is transmitted in the QLL establishment event or a subsequent QLL establishment event. When a challenge cannot be verified, the subsequent QLL establishment PDU may not be transmitted and the QLL establishment protocol 410 may be aborted. If the QLL establishment protocol is aborted, the proprietary device may return to the QLL standby state.

At 558, the first device may establish a proprietary link layer connection with the second device when it is determined that a sequence of the proprietary establishment PDUs have been exchanged with the second device. For example, referring to FIG. 4B, a QLL communication link may be established between the master device 402 and the slave device 404 once the challenge included in the QLL_EST_CONN_CONNECT_IND 417f may is verified by the master device 402.

At 560, the first device may communicate with the second device via the proprietary link layer connection. For example, referring to FIGS. 4A-4C, the master device 402 may communicate with the slave device 404 using the QLL communication link. For example, communications via the QLL communication link may include proprietary firmware updates, proprietary licensing of additional codes, and/or adding additional proprietary firmware components just to name a few.

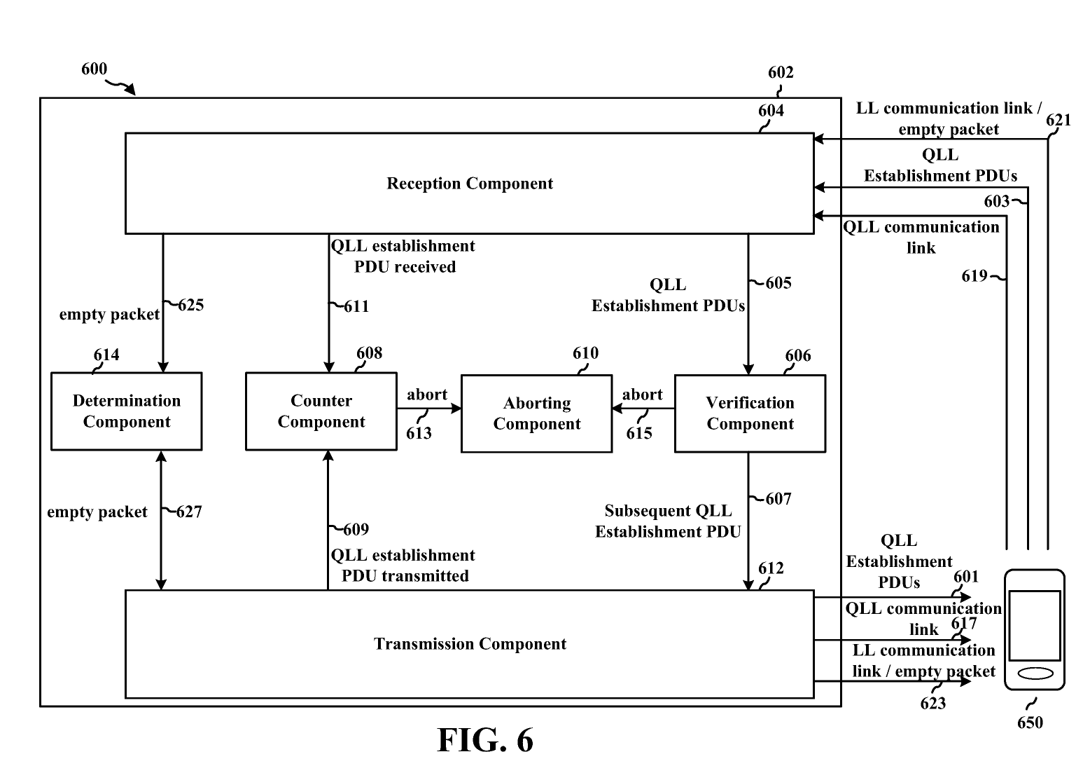

FIG. 6 is a conceptual data flow diagram 600 illustrating the data flow between different means/components in an exemplary apparatus 602. The apparatus may be a first device (e.g., central device 102, peripheral device 104, 106, 108, 110, 112, 114, wireless device 200, master device 402, slave device 404, the apparatus 602/602′) in communication with a second device 650 (e.g., central device 102, peripheral device 104, 106, 108, 110, 112, 114, wireless device 200, master device 402, slave device 404). The apparatus may include a reception component 604, a verification component 606, a counter component 608, an aborting component 610, a transmission component 612, and a determination component 614.

The reception component 604 and/or the transmission component 612 may be configured to establish a non-proprietary link layer connection 621, 623 with the second device 650. The reception component 604 may be configured to receive an empty packet during a non-proprietary link layer connection event from the second device 650. The transmission component 612 may be configured to transmit an empty packet during a non-proprietary link layer connection event to the second device 650.

One or more of the reception component 604 and/or the transmission component 612 may be configured to send a signal 625, 627 associated with the empty data packets (or LL data PDUs) received/transmitted during the non-proprietary link layer connection event to the determination component 614.

The determination component 614 may be configured to determine if a first set of empty non-proprietary link layer PDUs are exchanged with the second device via one or more channels during a non-proprietary link layer connection event. The determination component 614 may be configured to send a signal 627 to the reception component 604 and/or transmission component 612 indicating if empty packets were exchanged or if non-empty packets were exchanged.

The reception component 604 and/or the transmission component 612 may be configured to exchange proprietary establishment PDUs with the second device during at least one proprietary link establishment event via the one or more channels when it is determined that the first set of empty non-proprietary link layer PDUs are exchanged with the second device via the one or more channels. In certain aspects, the reception component 604 and/or the transmission component 612 may be configured to exchange proprietary establishment PDUs 601, 603 with the second device during at least one proprietary link establishment event via the one or more channels by transmitting or receiving a proprietary establishment request PDU 601, 603. In certain other aspects, the reception component 604 and/or the transmission component 612 may be configured to exchange proprietary establishment PDUs with the second device during at least one proprietary link establishment event via the one or more channels by receiving or transmitting a proprietary establishment response PDU 601, 603. In certain other aspects, the reception component 604 and/or the transmission component 612 may be configured to exchange proprietary establishment PDUs with the second device during at least one proprietary link establishment event via the one or more channels by transmitting or receiving a proprietary establishment authorization request PDU 601, 603. In certain other aspects, the reception component 604 and/or the transmission component 612 may be configured to exchange proprietary establishment PDUs with the second device during at least one proprietary link establishment event via the one or more channels by receiving or transmitting a first proprietary establishment authorization response PDU 601, 603. In certain other aspects, the reception component 604 and/or the transmission component 612 may be configured to exchange proprietary establishment PDUs with the second device during at least one proprietary link establishment event via the one or more channels by transmitting or receiving a second proprietary establishment authorization response PDU 601, 603. In certain other aspects, the reception component 604 and/or the transmission component 612 may be configured to exchange proprietary establishment PDUs with the second device during at least one proprietary link establishment event via the one or more channels by receiving or transmitting a proprietary establishment connection PDU 601, 603. The reception component 604 may be configured to send a signal 605 associated with QLL establishment PDUs received from the second device 650 to the verification component 606.

The reception component 604 and/or the transmission component 612 may be configured to delay an exchange of a subsequent proprietary establishment PDU until a subsequent proprietary link connection event when it is determined that the first set of empty non-proprietary link layer PDUs are not exchanged with the second device 650 via one or more channels during the non-proprietary link layer connection event.

The verification component 606 may be configured to determine if a challenge included in each of the proprietary establishment PDUs received by the first device can be verified. The verification component 606 may be configured to send a signal 607 indicating to the transmission component 612 that the challenge in a received QLL establishment PDU is verified and that a subsequent QLL establishment PDU may be transmitted to the second device 650. When the challenge cannot be verified, the verification component 606 may be configured to send a signal 615 to the aborting component 610 indicating that the QLL establishment procedure should be aborted. The aborting component 610 may be configured to abort the QLL establishment procedure when a challenge cannot be verified by the verification component 606.

The transmission component 612 may be configured to transmit a subsequent proprietary establishment PDU 601 after the challenge included in each of the proprietary establishment PDUs is verified.

The transmission component 612 may be configured to send a signal 609 each time a QLL establishment PDU 601 is transmitted to the second device 650. The reception component 604 may be configured to send a signal 611 each time a QLL establishment PDU 603 is received from the second device 650.

The counter component 608 may be configured to determine if a timeout event occurs based on a duration between transmitting a first proprietary establishment PDU (e.g., QLL establishment PDU) and receiving a second proprietary establishment PDU (e.g., QLL establishment PDU) in response to the first proprietary establishment PDU. The counter component 608 may be configured to reset a counter each time a proprietary establishment PDU is received before an end of the duration. The counter component 608 may be configured to send a signal 613 to the aborting component 610 indicating that a timeout event has occurred, and that the QLL establishment procedure should be aborted. The aborting component 610 may be configured to abort the QLL establishment procedure.

The reception component 604 and/or the transmission component 612 may be configured to establish a proprietary link layer connection 617, 619 with the second device 650 when it is determined that a sequence of the proprietary establishment PDUs have been exchanged with the second device 650. The reception component 604 and/or the transmission component 612 may be configured to communicate with the second device 650 via the proprietary link layer connection 617, 619.

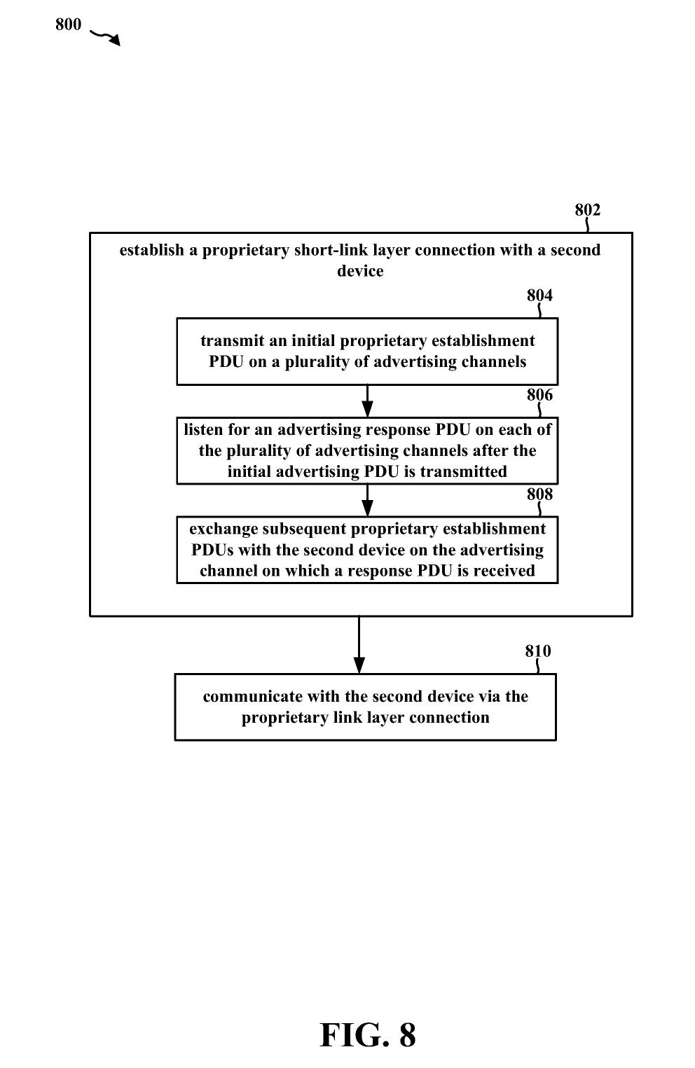

The apparatus may include additional components that perform each of the blocks of the algorithm in the aforementioned flowcharts of FIGS. 5A, 5B, and 8. As such, each block in the aforementioned flowcharts of FIGS. 5A, 5B, and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

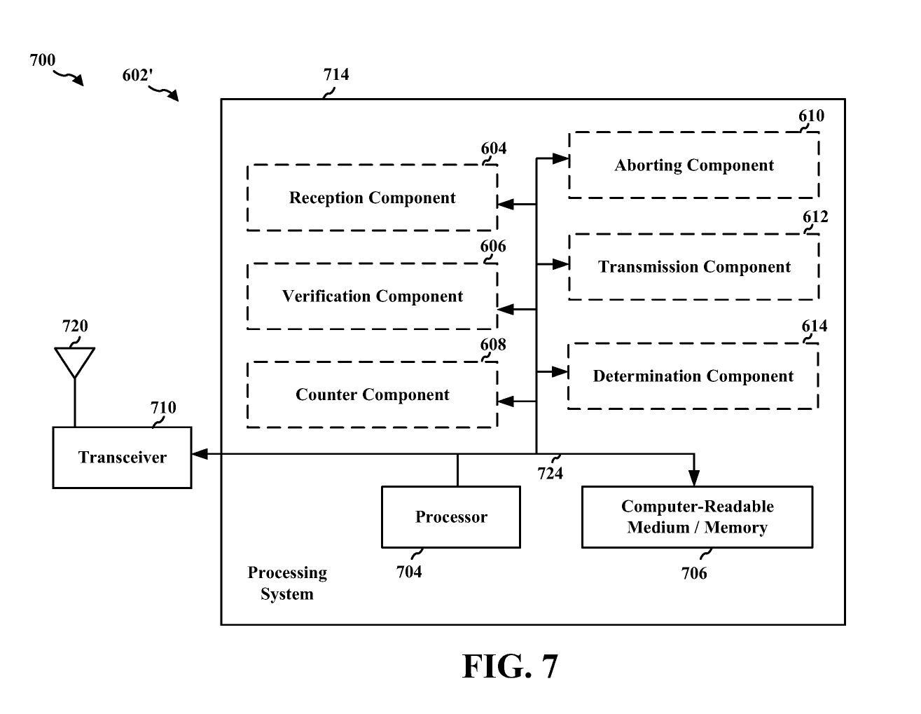

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 604, 606, 608, 610, 612, 614 and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714, specifically the reception component 604. In addition, the transceiver 710 receives information from the processing system 714, specifically the transmission component 612, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system 714 further includes at least one of the components 604, 606, 608, 610, 612, 614. The components may be software components running in the processor 704, resident/stored in the computer readable medium/memory 706, one or more hardware components coupled to the processor 704, or some combination thereof.

In certain configurations, the apparatus 602/602′ for wireless communication may include means for establishing a non-proprietary link layer connection with a second device. In certain configurations, the apparatus 602/602′ for wireless communication may include means for determining if a first set of empty non-proprietary link layer PDUs are exchanged with the second device via one or more channels during a non-proprietary link layer connection event. In certain other configurations, the apparatus 602/602′ for wireless communication may include means for exchanging proprietary establishment PDUs with the second device during at least one proprietary link establishment event via the one or more channels when it is determined that the first set of empty non-proprietary link layer PDUs are exchanged with the second device via the one or more channels. In certain aspects, the means for exchanging proprietary establishment PDUs with the second device during at least one proprietary link establishment event via the one or more channels may be configured to transmit or receive a proprietary establishment request PDU. In certain other aspects, the means for exchanging proprietary establishment PDUs with the second device during at least one proprietary link establishment event via the one or more channels may be configured to receive or transmit a proprietary establishment response PDU. In certain other aspects, the means for exchanging proprietary establishment PDUs with the second device during at least one proprietary link establishment event via the one or more channels may be configured to transmit or receive a proprietary establishment authorization request PDU. In certain other aspects, the means for exchanging proprietary establishment PDUs with the second device during at least one proprietary link establishment event via the one or more channels may be configured to receive or transmit a first proprietary establishment authorization response PDU. In certain other aspects, the means for exchanging proprietary establishment PDUs with the second device during at least one proprietary link establishment event via the one or more channels may be configured to transmit or receive a second proprietary establishment authorization response PDU. In certain other aspects, the means for exchanging proprietary establishment PDUs with the second device during at least one proprietary link establishment event via the one or more channels may be configured to receive or transmit a proprietary establishment connection PDU. In certain other configurations, the apparatus 602/602′ for wireless communication may include means for determining if a challenge included in each of the proprietary establishment PDUs received by the first device can be verified. In certain other configurations, the apparatus 602/602′ for wireless communication may include means for transmitting a subsequent proprietary establishment PDU after the challenge included in each of the proprietary establishment PDUs received by the first device is verified. In certain other configurations, the apparatus 602/602′ for wireless communication may include means for establishing a proprietary link layer connection with the second device when it is determined that a sequence of the proprietary establishment PDUs have been exchanged with the second device. In certain other configurations, the apparatus 602/602′ for wireless communication may include means for determining if a timeout event occurs based on a duration between transmitting a first proprietary establishment PDU and receiving a second proprietary establishment PDU in response to the first proprietary establishment PDU. In certain other configurations, the apparatus 602/602′ for wireless communication may include means for resetting a counter each time a proprietary establishment PDU is received before an end of the duration. In certain other configurations, the apparatus 602/602′ for wireless communication may include means for delaying an exchange of a subsequent proprietary establishment PDU until a subsequent proprietary link connection event when it is determined that the first set of empty non-proprietary link layer PDUs are not exchanged with the second device via one or more channels during the non-proprietary link layer connection event. In certain other configurations, the apparatus 602/602′ for wireless communication may include means for communicating with the second device via the proprietary link layer connection. The aforementioned means may be one or more of the aforementioned processor(s) 202, short-range communications controller 252, the proprietary controller 256, and/or radio 230 in FIG. 2, components of the apparatus 602 and/or the processing system 714 of the apparatus 602′ configured to perform the functions recited by the aforementioned means.

FIG. 8 is a flowchart 800 of a method of wireless communication. The method may be performed by a first device (e.g., central device 102, wireless device 200, master device 402, the apparatus 902/902′) in communication with a second device (e.g., peripheral device 104, 106, 108, 110, 112, 114, wireless device 200, slave device 404, the apparatus 950).

At 802, the first device may establish a proprietary link layer connection with a second device. For example, referring to FIG. 4E, the master device 402 may establish a QLL communication link with the slave device 404.

At 804, the first device may establish a proprietary link layer connection with a second device by transmitting an initial proprietary establishment PDU on a plurality of advertising channels. For example, referring to FIG. 4E, the QLL EST SERVICE REQ 417a on all of the advertising channels (e.g., channel n 421a and channel n+1 421b). The QLL establishment PDUs may be transmitted over the advertising channels 421a, 421b in a non-connectable advertising packet using a specially formatted advertising payload.

At 806, the first device may listen for an advertising response PDU on each of the plurality of advertising channels after the initial advertising PDU is transmitted. For example, referring to FIG. 4E, after sending the QLL_EST_SERVICE_REQ 417a, the master device 402 may listen for a response from the slave device 404 in the listening window 423 on each of the advertising channels 421a, 421b.

At 808, the first device may exchange subsequent proprietary establishment PDUs with the second device on the advertising channel on which a response PDU is received. For example, referring to FIG. 4E, master device 402 and the slave device may exchange subsequent QLL establishment PDUs 417b, 417c, 417d, 417e, 417f on one of the advertising channels 421a, 421b. In one aspect, each of the QLL establishment PDUs 417a, 417b, 417c, 417d, 417e, 417f includes an advertising payload.

At 810, the first device may communicate with the second device via the proprietary link layer connection. For example, referring to FIG. 4E, communications via the QLL communication link may include proprietary firmware updates, proprietary licensing of additional codes, and/or adding additional proprietary firmware components just to name a few.

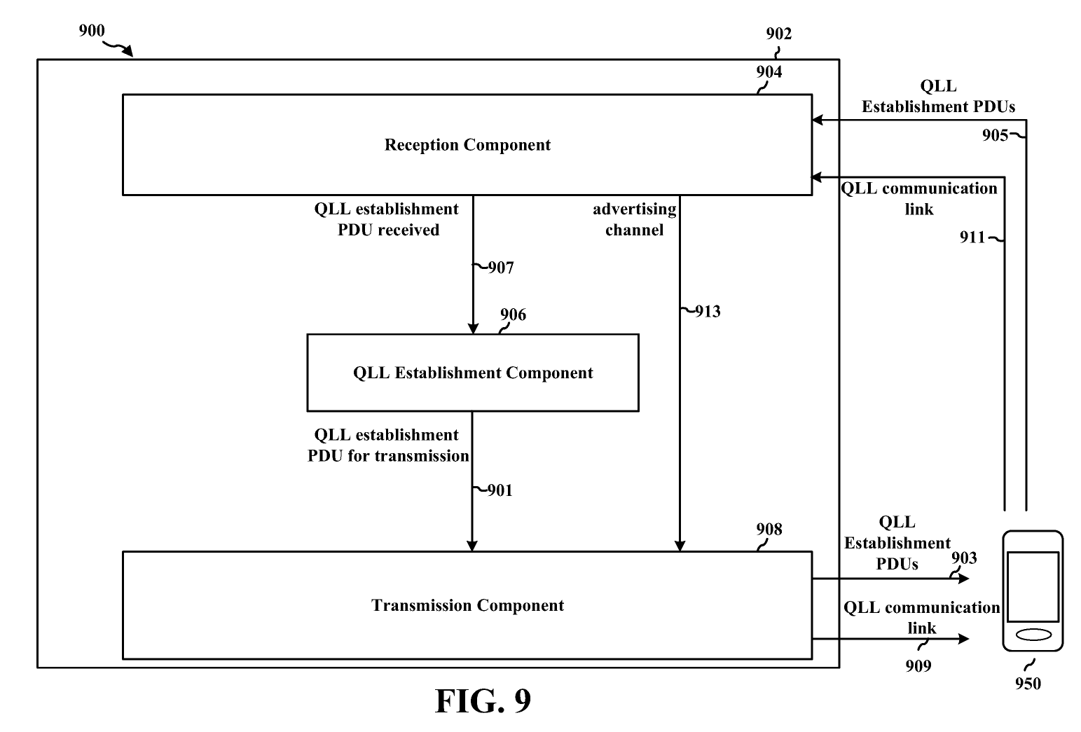

FIG. 9 is a conceptual data flow diagram 900 illustrating the data flow between different means/components in an exemplary apparatus 902. The apparatus may be a first device (e.g., central device 102, wireless device 200, master device 402, the apparatus 902/902′) in communication with a second device 950 (e.g., peripheral device 104, 106, 108, 110, 112, 114, wireless device 200, slave device 404). The apparatus may include a reception component 904, a QLL establishment component 906, and a transmission component 908.

One or more of the reception component 904, the QLL establishment component 906, and/or the transmission component 908 may be configured to establish a proprietary link layer connection with the second device 950.

In certain aspects, one or more of the reception component 904, the QLL establishment component 906, and/or the transmission component 908 may be configured to establish a proprietary link layer connection with the second device 950 by transmitting an initial proprietary establishment PDU on a plurality of advertising channels. For example, the QLL establishment component 906 may be configured to send a signal 901 associated with an initial proprietary establishment PDU (e.g., an initial QLL establishment PDU) to the transmission component 908. The transmission component 908 may be configured to transmit the initial proprietary establishment PDU 903 on a plurality of advertising channels to the second device 950.

In certain other aspects, one or more of the reception component 904, the QLL establishment component 906, and/or the transmission component 908 may be configured to establish a proprietary link layer connection with the second device 950 by listening for a response proprietary establishment PDU 905 on each of the plurality of advertising channels after the initial advertising PDU is transmitted. The reception component 904 may be configured to listen for a response proprietary establishment PDU 905 on each of the plurality of advertising channels after the initial advertising PDU is transmitted. The reception component 904 may be configured to send a signal 907 associated with each of the received proprietary establishment PDUs to the QLL establishment component 906. The reception component 904 may be configured to send a signal 913 associated with the advertising channel on which the response proprietary establishment PDU is received. The transmission component 908 may be configured to transmit subsequent proprietary establishment PDUs to the second device 950 via the advertising channel indicated by signal 913.

In certain other aspects, one or more of the reception component 904, the QLL establishment component 906, and/or the transmission component 908 may be configured to establish a proprietary link layer connection with the second device 950 by exchanging subsequent proprietary establishment PDUs 903, 905 with the second device 950 on the advertising channel on which the response proprietary establishment PDU is received. Once a proper sequence of proprietary establishment PDUs (e.g., see FIG. 4B) has been exchanged between the apparatus 902 and the second device 950, the proprietary link layer connection 909, 911 may be established with the second device.

In certain other aspects, one or more of the reception component 904, the QLL establishment component 906, and/or the transmission component 908 may be configured to communicate with the second device 950 via the proprietary link layer connection 909, 911.

The apparatus may include additional components that perform each of the blocks of the algorithm in the aforementioned flowcharts of FIGS. 5A, 5B, and 8. As such, each block in the aforementioned flowcharts of FIGS. 5A, 5B, and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

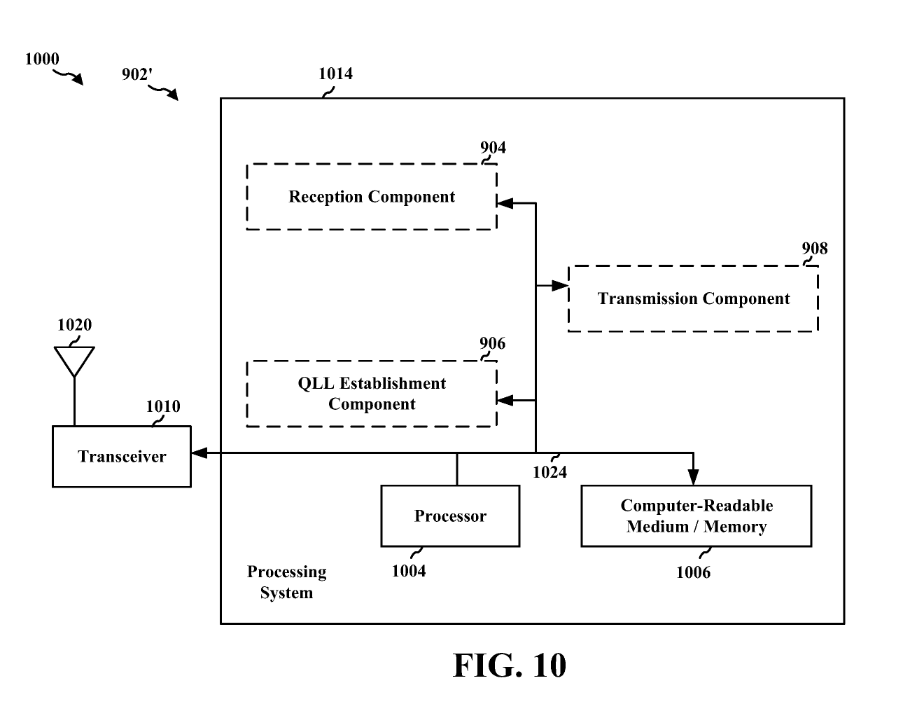

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, 908, and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 908, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906, 908. The components may be software components running in the processor 1004, resident/stored in the computer readable medium/memory 1006, one or more hardware components coupled to the processor 1004, or some combination thereof.

In certain configurations, the apparatus 902/902′ for wireless communication may include means for establishing a proprietary link layer connection with a second device. In certain aspects, the means for establishing the proprietary link layer connection with the second device may be configured to transmit an initial proprietary establishment PDU on a plurality of advertising channels. In certain other aspects, the means for establishing the proprietary link layer connection with the second device may be configured to listen for a response proprietary establishment PDU on each of the plurality of advertising channels after the initial advertising PDU is transmitted. In certain other aspects, the means for establishing the proprietary link layer connection with the second device may be configured to exchange subsequent proprietary establishment PDUs with the second device on the advertising channel on which the response proprietary establishment PDU is received. In one aspect, each proprietary establishment PDU may include an advertising payload. In certain configurations, the apparatus 902/902′ for wireless communication may include means for communicating with the second device via the proprietary link layer connection.

The aforementioned means may be one or more of the aforementioned processor(s) 202, short-range communications controller 252, the proprietary controller 256, and/or radio 230 in FIG. 2, components of the apparatus 902 and/or the processing system 1014 of the apparatus 902′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a first device, comprising:
establishing a non-proprietary link layer connection with a second device;
determining if a first set of empty non-proprietary link layer protocol data units (PDUs) are exchanged with the second device via one or more channels during a non-proprietary link layer connection event;
exchanging proprietary establishment PDUs with the second device during at least one proprietary link establishment event via the one or more channels when it is determined that the first set of empty non-proprietary link layer PDUs are exchanged with the second device via the one or more channels;
establishing a proprietary link layer connection with the second device when it is determined that a sequence of the proprietary establishment PDUs have been exchanged with the second device; and
communicating with the second device via the proprietary link layer connection.

2. The method of claim 1, wherein the exchanging proprietary establishment PDUs with the second device during the at least one proprietary link establishment event comprises:
transmitting or receiving a proprietary establishment request PDU;
receiving or transmitting a proprietary establishment response PDU;
transmitting or receiving a proprietary establishment authorization request PDU;
receiving or transmitting a first proprietary establishment authorization response PDU;
transmitting or receiving a second proprietary establishment authorization response PDU;
receiving or transmitting a proprietary establishment connection PDU.

3. The method of claim 2, further comprising:
determining if a challenge included in each of the proprietary establishment PDUs received by the first device can be verified; and
transmitting a subsequent proprietary establishment PDU after the challenge included in each of the proprietary establishment PDUs received by the first device is verified.

4. The method of claim 2, further comprising:
determining if a timeout event occurs based on a duration between transmitting a first proprietary establishment PDU and receiving a second proprietary establishment PDU in response to the first proprietary establishment PDU.

5. The method of claim 4, further comprising:
resetting a counter each time a proprietary establishment PDU is received before an end of the duration.

6. The method of claim 1, further comprising:
delaying an exchange of a subsequent proprietary establishment PDU until a subsequent proprietary link connection event when it is determined that the first set of empty non-proprietary link layer PDUs are not exchanged with the second device via one or more channels during the non-proprietary link layer connection event.

7. A method of wireless communication of a first device, comprising:
establishing a proprietary link layer connection with a second device by:
transmitting an initial proprietary establishment PDU on a plurality of advertising channels,
listening for a response proprietary establishment PDU on each of the plurality of advertising channels after the initial advertising PDU is transmitted, and
exchanging subsequent proprietary establishment PDUs with the second device on the advertising channel on which the response proprietary establishment PDU is received; and
communicating with the second device via the proprietary link layer connection.

8. The method of claim 7, wherein each proprietary establishment PDU includes an advertising payload.

9. An apparatus for wireless communication of a first device, comprising:
a memory; and
at least one processor coupled to the memory and configured to:
establish a non-proprietary link layer connection with a second device; and
determine if a first set of empty non-proprietary link layer packet data units (PDUs) are exchanged with the second device via one or more channels during a non-proprietary link layer connection event;
exchange proprietary establishment PDUs with the second device during at least one proprietary link establishment event via the one or more channels when it is determined that the first set of empty non-proprietary link layer PDUs are exchanged with the second device via the one or more channels;
establish a proprietary link layer connection with the second device when it is determined that a sequence of the proprietary establishment PDUs have been exchanged with the second device; and
communicate with the second device via the proprietary link layer connection.

10. The apparatus of claim 9, wherein the at least one processor is configured to exchange proprietary establishment PDUs with the second device during the at least one proprietary link establishment event by:
transmitting or receiving a proprietary establishment request PDU;
receiving or transmitting a proprietary establishment response PDU;
transmitting or receiving a proprietary establishment authorization request PDU;
receiving or transmitting a first proprietary establishment authorization response PDU;
transmitting or receiving a second proprietary establishment authorization response PDU;
receiving or transmitting a proprietary establishment connection PDU.

11. The apparatus of claim 10, wherein the at least one processor is further configured to:
determine if a challenge included in each of the proprietary establishment PDUs received by the first device can be verified; and
transmit a subsequent proprietary establishment PDU after the challenge included in each of the proprietary establishment PDUs received by the first device is verified.

12. The apparatus of claim 10, wherein the at least one processor is further configured to:
determine if a timeout event occurs based on a duration between transmitting a first proprietary establishment PDU and receiving a second proprietary establishment PDU in response to the first proprietary establishment PDU.

13. The apparatus of claim 12, wherein the at least one processor is further configured to:
reset a counter each time a proprietary establishment PDU is received before an end of the duration.

14. The apparatus of claim 9, wherein the at least one processor is further configured to:
delay an exchange of a subsequent proprietary establishment PDU until a subsequent proprietary link connection event when it is determined that the first set of empty non-proprietary link layer PDUs are not exchanged with the second device via one or more channels during the non-proprietary link layer connection event.

15. An apparatus for wireless communication of a first device, comprising:
a memory; and
at least one processor coupled to the memory and configured to:
establish a proprietary link layer connection with a second device by:
transmitting an initial proprietary establishment PDU on a plurality of advertising channels,
listening for a response proprietary establishment PDU on each of the plurality of advertising channels after the initial advertising PDU is transmitted, and
exchanging subsequent proprietary establishment PDUs with the second device on the advertising channel on which the response proprietary establishment PDU is received; and
communicate with the second device via the proprietary link layer connection.

16. The apparatus of claim 15, wherein each proprietary establishment PDU includes an advertising payload.
